(19) United States
(12) Patent Application Publication
(10) Pub. No.: US 2009/0006119 A1
(43) Pub. Date: Jan. 1, 2009

(54) WEBSITE AFFILIATION ANALYSIS METHOD AND SYSTEM

(75) Inventors: Alex Langshur, Medford, MA (US); Tyler Gibbs, Carp (CA)

Correspondence Address: VOLPE AND KOENIG, P.C., UNITED PLAZA, SUITE 1600, 30 SOUTH 17TH STREET, PHILADELPHIA, PA, 19103, US

(73) Assignee: PUBLICINSITE LTD., Ottawa (CA)

(21) Appl. No.: 12/118,141

(22) Filed: May 9, 2008

Related U.S. Application Data
(60) Provisional application No. 60/917,140, filed on May 10, 2007.

(51) Int. Cl. G06Q 99/00

(52) U.S. Cl. 705/1

(57) ABSTRACT

A system, method and apparatus for determining an affiliation of visitors to a web-site under scrutiny is disclosed, having a log analyzer, a filter updater, and optionally, one or more affiliation lookup modules and a report creator. The log analyzer accepts and processes log data information relating to visitor traffic at the web-site under scrutiny, such as may be compiled by a conventional web data logger. The log analyzer subjects each log data entry to a series of cascading stakeholder filters, each of which may contain certain constituent filter criteria. If one of the criteria is satisfied by the log data entry, the entry is affiliated or associated with the corresponding stakeholder and stored in a database in association with such stakeholder. If the log data entry is not affiliated with any of the stakeholder filters, it is relegated to a remainder bin for processing by the filter updater. The filter updater attempts to generate filter criteria to trap the log data entry and stores such criteria in one of the stakeholder filters. The choice of stakeholder filter is governed by an affiliation identification exercise which may involve invocation of one or more of the affiliation lookup modules. Preferably, the affiliation identification exercise is facilitated by identification of a domain name corresponding to the IP address maintained in the log data entry. Preferably, the filter updating process operates in parallel with the processing of the log data entries. Further, advantageously, affiliation identification exercises in a first system may provide assistance in affiliation identification in a second system by cross-pollination.

### RELATED DISCLOSURES

The present disclosure claims priority from U.S. Patent Application No. 60/917,140, which is incorporated herein by reference.

### FIELD OF THE DISCLOSURE

The present disclosure relates to market research, and more particularly to a new and improved system and method of conducting market research on visitors to web-sites.

### BACKGROUND

Most customer-oriented businesses perform market research to one degree or another. Less sophisticated businesses may simply want to know some information about a specific prospect, before commencing a proposal to such prospect. More sophisticated market research programs may involve understanding the business' attraction to customers falling within broad demographic categories such as geographic region, age, gender, ethnicity, education, industry sector and household income.

If a business is familiar with its most approachable target demographic, it may choose to concentrate its marketing budget in resources, such as print, radio and television service providers, whose reach and appeal may prefer one or more sub-groups within such target demographic over others. Alternatively, if a business wishes to expand its target demographic to other sub-groups, it may devote budget to resources that prefer such new target demographic.

Accordingly, there exist numerous resources who provide market research into such demographic categories and sub-categories and who attempt to quantify for businesses, the attraction and extent of their reach into each of these categories and sub-categories.

For example, radio and television broadcasters devote tremendous resources to understanding which demographic categories and sub-categories may at any time be receiving their programming, through a number of market research techniques, including but not limited to retaining a statistically significant and representative segment of the viewing public. Such segment members are paid for the right to interpose a monitoring box between the signal input entering the homes of the segment members and the television or radio set in order to precisely record the times, channels and programs received, and to note when and to what extent the channels and programs are changed. Such passive monitoring of the viewing habits of the segment members is often typically supplemented by requesting that the segment members record, in a log, their observations and viewing practices.

While the imposition of such monitoring boxes is intended to be at least notionally minimally intrusive, nevertheless, the surrounding circumstances ensure that such monitoring is overt. Accordingly, there is always the risk, and indeed, it is likely to be the case, that the results recorded by the monitoring boxes will reflect knowledge of the presence of the monitoring. For example, if one of the segment members wishes to watch some programming of which he or she is for some reason ashamed, he or she may go to some effort to actively disguise this viewing pattern, for example, to attend at some other location to view the programming, such as a neighbour's house or a bar, or an additional, unmonitored device elsewhere in his or her own home.

Furthermore, even without any overt attempts to circumvent the monitoring process, such monitors are by their very nature somewhat less than comprehensive. For a large variety of reasons, it is impractical to expect that such monitors will be installed on every television set, so that inevitably, some data, even of the registered segment members will not be recorded.

Finally, even were perfect compliance by a given user to be achieved, the monitoring program remains at best a statistical technique, relying on statistical theory applied to a relatively small set of observations to extrapolate to large-scale behaviour. While in many cases, such extrapolations will be very accurate in a statistical sense, they cannot and do not purport to be accurate representations of what was actually viewed.

Other conventional market research methodologies may be appropriate to supplement such viewing monitors, or for application to customers other than radio and television viewers. These include conducting consumer surveys, telephone interviews and/or focus groups. Such approaches are similar to the viewing monitors in that they are overt to the persons being surveyed, incomplete and statistically-based. Further, they suffer from additional disadvantages in that they are generally expensive to conduct and increasingly, there is a resistance on the part of the public to participate in such activities, which increases their cost and complexity and may adversely impact their accuracy and rigour, in that presumably, increasingly certain demographic segments of the public may decline to participate at a greater rate than others, resulting in a skew of any statistical results that may be derived therefrom.

The rapid development of the Internet as a key delivery channel not only for products and services, but also as an advertising medium is related to certain unique features of the Internet that differentiate it from other communications and/or information delivery paradigms.

Primary among these features is the capability of Internet users to remain relatively anonymous. As a general rule, Internet users are entitled to create their own identities, through their e-mail address. While many users choose e-mail addresses that reflect aspects of their true identities (e.g. john.smith@aol.com), others have adopted names or personas completely unrelated thereto. In some instances, the reasons are quaint, reflecting a characteristic or persona to which the user aspires (e.g. bigdave@yahoo.com), while in other instances, the reasons may be much more malevolent, as evidenced by the ever-increasing reports of phishing and other instances of Internet fraud.

This capacity to be anonymous is not restricted only to the name portion of an e-mail address (that is, before the “@” symbol), but may also be manifested in the domain name portion (that is, after the “@” symbol). Many e-mail addresses are associated with a domain name corresponding to an enterprise (e.g. uspto.com). Nevertheless, the domain name registration process, which is entirely on-line, permits domain names to be crafted out of thin air and may only appear to represent an existing and thriving entity (e.g. www.imperial_lamps_and_jet_airplanes.net).

To some extent, such registration processes expect that there be some relation to existing enterprises. For example, many top-level and country level domain name registration services demand that an applicant for such a domain name possess a corresponding business name or trade-mark registration. They provide remedies, through domain name resolution services, in the event that application for or registration of a domain name (e.g. pepsii.com) that is confusingly similar to an existing (and usually well-known) enterprise in order to appropriate good will from such enterprise (cybersquatting), by which the domain name may be, on application by the enterprise, re-registered in the enterprise's name. However, the Internet remains replete with misleading domain names.

Further, the Internet has come to be viewed as somewhat of a great leveller between the marketing reach of wealthier companies and small and medium sized enterprises (SMEs). The relative low cost to register a domain name and to set up a web-site, and the relative equality by which the web-site of an individual or an SME, as opposed to a Fortune 500 company, may be accessed world-wide, has led to unprecedented use of the Internet as a marketing and information dissemination medium. Indeed, a dedicated individual may, by dint of only effort and knowledge of how web browsers operate, be able to cause his or her web-site to attract greater attention than more established enterprises and to appear, for all intents and purposes, as a thriving ongoing business empire.

However, these very features and advantages pose considerable difficulties for the purposes of developing effective market research tools to understand the demographic appeal of a particular web-site, which can undermine the strength of the Internet as an effective tool for information dissemination and commerce.

The need for tools and resources to improve the targeting of online communications is reflected in the increasing number and use of niche-oriented websites. Internet users are “voting with their mice” and choosing in greater numbers to visit web sites that are aligned to their specific interests, often to the detriment of the “all purpose” web sites.

Development of tools to more appropriately target Internet users in a manner previously achieved in conventional communications media and even beyond, may reduce indiscriminate broadcasting of information and may indeed assist in more sophisticated browsers and readers.

At present, most approaches to identifying and monitoring demographic categories of Internet users has been of the conventional variety. Many web-sites now provide a registration section whereby visitors to the web-site are expressly invited or persuaded, by way of incentives, newsletters and/or contests, to disclose identifying information to the webmaster, whereby registrants may be invited to participate in focus groups, surveys, interviews and the like to obtain such demographic information. Some typical approaches include conducting pop-up or user-selected surveys on pages accessible from a web-site home page, off-line phone or e-mail surveys of visitors who have registered and chosen to disclose their contact information, or to invite registered visitors to participate in a focus group.

Often the self-registration aspect of such approaches calls for art in determining how much information to request up front during the registration process, so as to minimize the impact of a subsequent refusal or failure to participate in the activity on the ability to secure the demographic information, balanced against the inconvenience imposed at the outset of the registration process, which may dissuade users from registering in the first place.

Further, the above-enumerated drawbacks of such conventional market research techniques are equally applicable to visitors to the Internet. Indeed, the sheer increase in traffic over the Internet as compared against conventional communications vehicles, may exacerbate the situation, given that a sample of registrants to a web-site that is comparable in actual numbers to samples of the public obtained in a television market, may, as a result of the broader and arguably more convenient reach of the Internet, represent a smaller sample size relative to the television market, with a concomitant reduction in the statistical accuracy of the survey exercise.

There are tools developed specifically for the Internet to perform a manner of market research. For example, U.S. Pat. No. 6,223,348 entitled “System and method for Analyzing Remote Traffic Data in a Distributed Computing Environment” and issued Aug. 29, 2000 to Boyd et al. discloses a system, method and storage medium for analyzing traffic hits in a distributed computing environment. The traffic hits are allocated to at least one results table according to its data type and the discrete reporting period in which it occurred. The data types identified by Boyd et al. are limited to geographic information, such as U.S. and international Internet addresses, including full company name, city, state and country, which may be directly or inferentially derivable from the context of the traffic hit. No information is provided as to how such information may be inferentially obtained from the data communicated in the traffic hit.

It is also known to apply so-called web loggers to individual web-sites in order to record raw traffic hits of visitors to the web-site and indeed to specific pages thereof. Thus, in a coarse manner, certain demographic information may be obtained, such as time of day, specific page accessed and, indirectly, geographic location of the domain from which the user is visiting the site, in that once the IP address and/or host name has been obtained from the web logger, geographic location may be obtained using other tools from the IP address and/or host name.

However such approaches are unable to categorize the visitors by any other type of affiliation, unless the visitors voluntarily identify such affiliation.

In respect of the geographic information, discussed both in Boyd et al. and obtainable from information captured by web-loggers, it is known that not infrequently, such information is inaccurate, or at a minimum misleading. For example, a domain may be maintained by a business having a head office in Omaha, Nebr. and a satellite office in Las Vegas, Nev. An employee of the business working in the satellite office may choose to visit a web-site using Internet access provided by the business. Because the domain set up by the business is maintained at its head office, the geographic information returned by a web-logger attached to the web-site from a review of the Internet address of the user will show its geographic location as being Omaha, Nebr., rather than Las Vegas, Nev. By the same token, individual users accessing a web-site through an Internet Service Provider (ISP), may return geographic information indicative not of the location from which the individual user accessed the web-site, but that of the domain maintained by the ISP, which may be different.

In any event, such coarse demographic information is often insufficient to make informed decisions regarding the provision of web-site or other information content to attract or to service a desired demographic segment. Indeed, irrespective of the detail and accuracy of such demographic information, the demographic categories for which information is provided may not be the categories for which information is desired by the web-site operator in that they do not accurately characterize the segment of the population of interest.

### SUMMARY OF THE DISCLOSURE

The present disclosure provides a method and system for identifying stake-holders of interest to a web-site under scrutiny and developing models for categorizing actual visitors to the web-site according to the identified stake-holders based upon actual past samples of traffic at the web-site.

Furthermore, the present disclosure permits the models so developed to be applied on an ongoing basis thereafter to categorize additional visitors to the web-site of interest according to the identified stake-holders and profiles derived therefrom, so as to provide an actual, as opposed to a statistical representation of the demographic categories of the web-site visitors. The inventive system is covert, so that any bias arising from knowledge of the monitoring system is effectively minimized.

The models make use of sophisticated analysis tools and proxies to generate realistic, useful and hitherto unavailable observations regarding demographic tendencies of visitors to the web-site and may be applied to generate policies and approaches to not only the provision of information on the web-site but also the strategic direction of the entity represented by the web-site.

Preferably, the models include observations regarding the industry sector of visitors and whether the visitors are accessing the web-site for work or for personal reasons. More preferably, the models include observations regarding the specific preferences of the identified stake-holders, as opposed to generalized and frequently unhelpful aggregate information of the visitors as a whole.

The present disclosure maintains a database of the models and categories created thereunder from across a plurality of client web-sites to permit cross-fertilization and significantly improved visitor categorization success rates approaching the theoretical limits of such categorization.

According to a first broad aspect of an embodiment of the present disclosure there is disclosed a system for determining an affiliation of at least one visitor to a web-site under scrutiny, the system comprising: a filter updater for maintaining at least one stakeholder filter and at least one constituent criterion thereof; and a log analyzer for comparing a log data entry corresponding to one of the at least one visitors against at least one constituent criteria of one of the at least one stakeholder filters and for storing it in a database in association with one of the at least one stakeholder filters if it satisfies one of the at least one constituent criteria thereof; wherein the one of the at least one visitors associated with the log data entry may be affiliated with a stakeholder corresponding to the stakeholder filter whose constituent criterion the log data entry satisfies.

According to a second broad aspect of an embodiment of the present disclosure there is disclosed a method for determining an affiliation of at least one visitor to a web-site under scrutiny, the method comprising the steps of: (a) maintaining at least one stakeholder filter and at least one constituent criterion thereof; (b) comparing a log data entry corresponding to one of the at least one visitor against each of the at least one constituent criteria of each of the at least one stakeholder filter; and (c) storing it in a database in association with one of the at least one stakeholder filters if it satisfies one of the at least one constituent criteria thereof; wherein the one of the at least one visitors associated with the log data entry may be affiliated with a stakeholder corresponding to the stakeholder filter whose constituent criterion the log data entry satisfies.

According to a third broad aspect of an embodiment of the present disclosure there is disclosed a filter updater for use in a system for determining an affiliation of at least one visitor to a web-site under scrutiny, the filter updater for maintaining at least one stakeholder filter and at least one constituent criterion thereof, whereby a log data entry corresponding to one of the at least one visitors may be compared against one of the at least one constituent criteria of one of the at least one stakeholder filters and stored in a database in association with one of the at least one stakeholder filters if it satisfies one of the at least one constituent criteria thereof, so that one of the at least one visitors associated with the log data entry may be affiliated with a stakeholder corresponding to the stakeholder filter whose constituent criterion was satisfied by the log data entry.

According to a forth broad aspect of an embodiment of the present disclosure there is disclosed a log analyzer for use in a system for determining an affiliation of at least one visitor to a web-site under scrutiny, for comparing a log data entry corresponding to one of the at least one visitors against each of at least one constituent criterion in each of at least one stakeholder filter and for storing the log data entry in a database in association with one of the at least one stakeholder filters if it satisfies one of the at least one constituent criteria thereof, wherein the one of the at least one visitors associated with the log data entry may be affiliated with a stakeholder corresponding to the stakeholder filter whose constituent criterion the log data entry satisfies.

According to a fifth aspect of an embodiment of the present disclosure there is disclosed an affiliation lookup module for use in a system for determining an affiliation of at least one visitor to a web-site under scrutiny, for accepting a log data entry corresponding to one of the at least one visitors and returning affiliation identification data corresponding thereto by which the log data entry may be identified as being associated with one of at least one stakeholder.

### BRIEF DESCRIPTION OF THE DRAWINGS

The embodiments of the present disclosure will now be described by reference to the following figures, in which identical reference numerals in different figures indicate identical elements and in which:

FIG. 1 is a simplified system block diagram of an example embodiment of the present disclosure;

FIG. 2 is an example of log data entries in the log data store of FIG. 1;

FIG. 3 is a flow chart of example processing steps performed by the log analyzer of FIG. 1;

FIG. 4 is a flow chart of example processing steps performed by the internal DNS processor of FIG. 1;

FIG. 5 is an example of affiliated data entries in the visitor database of FIG. 1;

FIG. 6 is a flow chart of example processing steps performed by the filter updater of FIG. 1;

FIG. 7 is an example format of filter definitions in the filter configuration store of FIG. 1;

FIG. 8 is a flow chart of example processing steps performed by the filter updater of FIG. 1 to create a filter criterion;

FIG. 9 is an example report created by the report creator of FIG. 1, showing a relative proportion of all visitors to a web-site under scrutiny occupied by each stakeholder;

FIG. 10 is an example report created by the report creator of FIG. 1, showing which sections of the web-site under scrutiny are most popular with each stakeholder;

FIG. 11 is an example report created by the report creator of FIG. 1, showing which individual entities corresponding to a single key stakeholder access the web-site under scrutiny; and

FIG. 12 is an example report created by the report creator of FIG. 1, showing what topics and content of a web-site under scrutiny are preferred by members of a single key stakeholder.

### DETAILED DESCRIPTION OF THE PREFERRED EMBODIMENTS

The present disclosure will now be described for the purposes of illustration only, in conjunction with certain embodiments. It is to be understood that other objects and advantages of the present invention will be made apparent by the following description of the drawings according to the present invention.

A method and system is described for identifying profiles of interest to a web-site under scrutiny and developing models for affiliating actual visitors to the web-site to the identified profile based upon actual historical web-site traffic.

A profile, for the purposes of the present discussion, is a category of visitor of interest to the web-site under scrutiny. A profile may be defined as a single or a superset of stakeholders.

A stakeholder is an atomic value of a category of a visitor of interest to the web-site under scrutiny. Any number of stakeholders may be identified, and they may be of any number of types of affiliation.

An affiliation is a characteristic by which the visitors to the web-site under scrutiny may be characterized or catalogued. For example, some web-sites may wish to understand the breakdown of visitors by their industry sectors and may apply a sectoral affiliation to the inventive system.

In this case, the list of potential profiles, for example, for a web-site that is operated by a public health agency of a government, for example, the Center for Disease Control, may include the following: health care institutions (hospitals); health maintenance organizations, federal and state health agencies, international health organizations, first responder organizations (international, state and local), the media (national and international).

It should be noted that certain affiliation values are typically of greater interest to the web-site under scrutiny 105 than others, even those which are within the same category. For example, in the scenario listed above, a mumps outbreak in the Northeastern United States would require that greater emphasis may be placed on visitors from health care institutions located in the Northeastern United States. In such situations, the profiles may be identified to provide greater granularity for the more important affiliation values. For example, the list of profiles could be modified to list separately each of the health care providers in the Northeastern states due, and only provide information on the entirety of the rest of the United South states.

This is accomplished through the use of stakeholders and profiles. In this situation, each of the individual state-based health care provider could be identified as a separate stakeholder, while a single profile corresponding to other health care providers in the remaining states would consist of multiple stakeholders each corresponding to one of the states in this region.

In some instances, typically for expediency and because of the extent of the granularity of information that may be derived from analysis of the log data entries, some stakeholders may themselves be broader in scope relative to other stakeholders.

As indicated, the type of affiliation will largely determine the type of stakeholder. The identification of stakeholders will in most instances be specific or unique to the web-site under scrutiny 105.

In some cases, complex profiles may be built up not only from constituent stakeholders, but from additional information provided concerning a visitor.

For example, a profile consisting of an “at-home American” visitor may be defined as a visitor from an Internet Service Provider (ISP) based in any of the United States that provides residential service only, or a visitor from an ISP based in any of the states who accesses a page between 7:00 pm and 6:00 am local time. The time entry is used in this case to exclude those users who may access a web-site from an Internet café or a business that uses the same ISP and who may not therefore fit the profile, it being considered more likely that a home user would operating during the evening hours. Those having ordinary skill in this art will readily appreciate that the desired time of day range may also vary depending upon the criteria adapted for the web-site under scrutiny.

Additionally, stakeholders may be defined based on different affiliation categories. For example, one set of stakeholders may rely on a geographic affiliation category, while another set may rely on an industry affiliation category (e.g. oil producers), and others on a sector (e.g. extractive resources such as mining, oil and gas). Stakeholders from one or several sets that rely on different affiliation categories may be combined into a single profile.

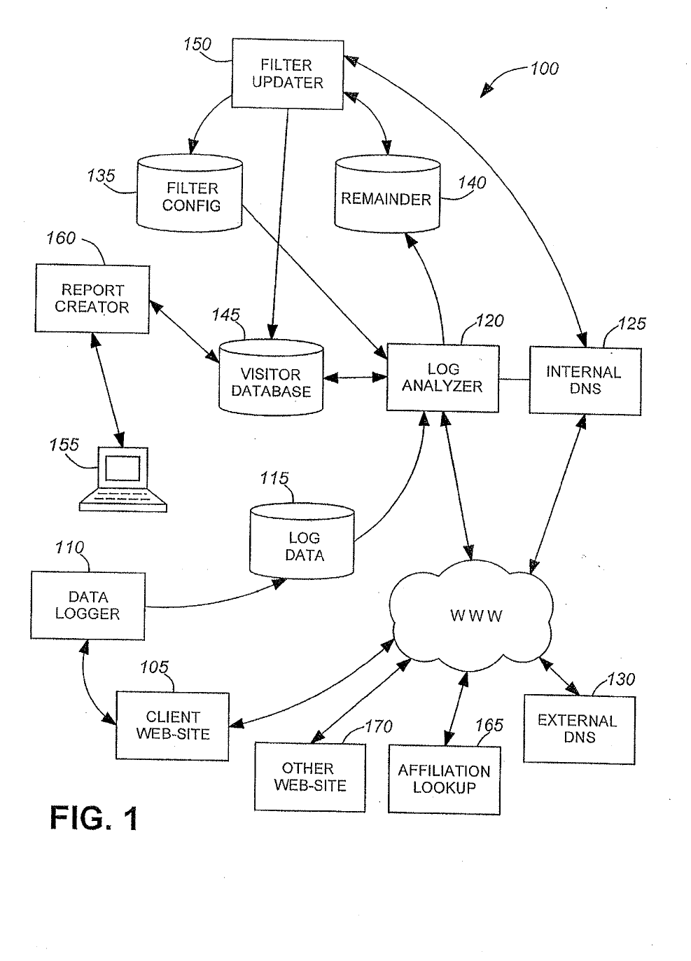

Referring first to FIG. 1, there is shown a simplified block diagram of an example embodiment. The system, shown generally at 100, may be understood to comprise a plurality of processors, including a web server and data logger 110, a log analyzer 120, an internal DNS processor 125, a filter updater 150, a report creator 160 and a user terminal 155, as well as a plurality of databases, including a log data store 115, a filter configuration store 135, a remainder bin 140 and a visitor database 145. The inventive system 100 may optionally interact with a number of processes, including an external DNS lookup module 130 and any other affiliation lookup module 165, as well as a number of web-sites 170, including a client web-site under scrutiny 105.

The web server and data logger 110 is associated with a web-site under scrutiny 105 for which visitor information and demographics is desired and monitors all web-traffic to the web-site under scrutiny 105 along the Internet 110. The web server and_data logger 110, which is entirely conventional, may be one of many versions of which are well known in the art, such as Microsoft IIS, Apache, Tomcat, among others.

The web server and data logger 110 gathers information relating to each visitor and stores the data in the log data store 115.

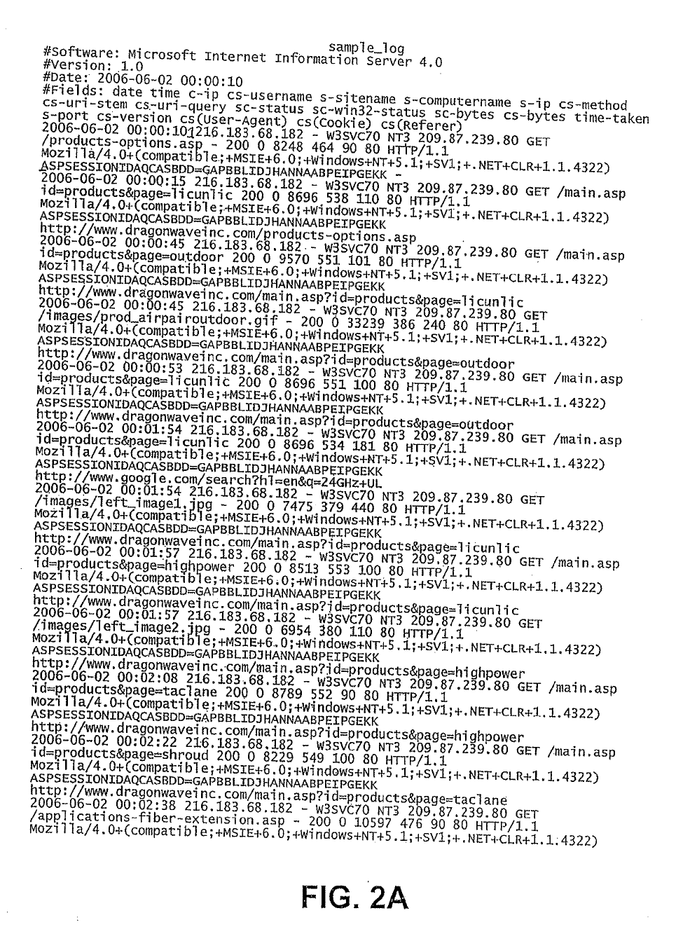

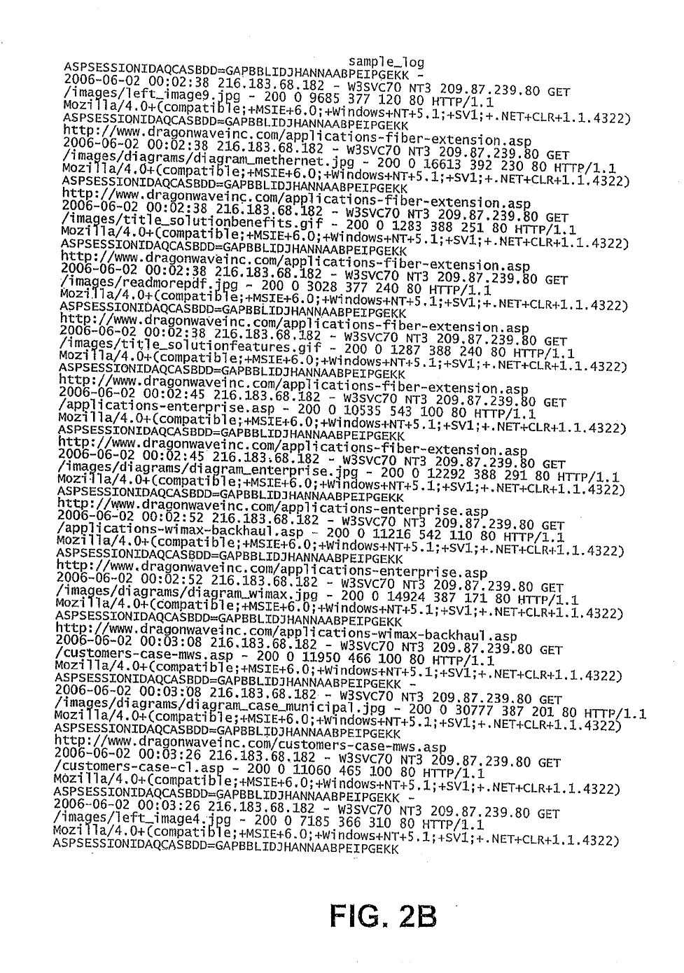

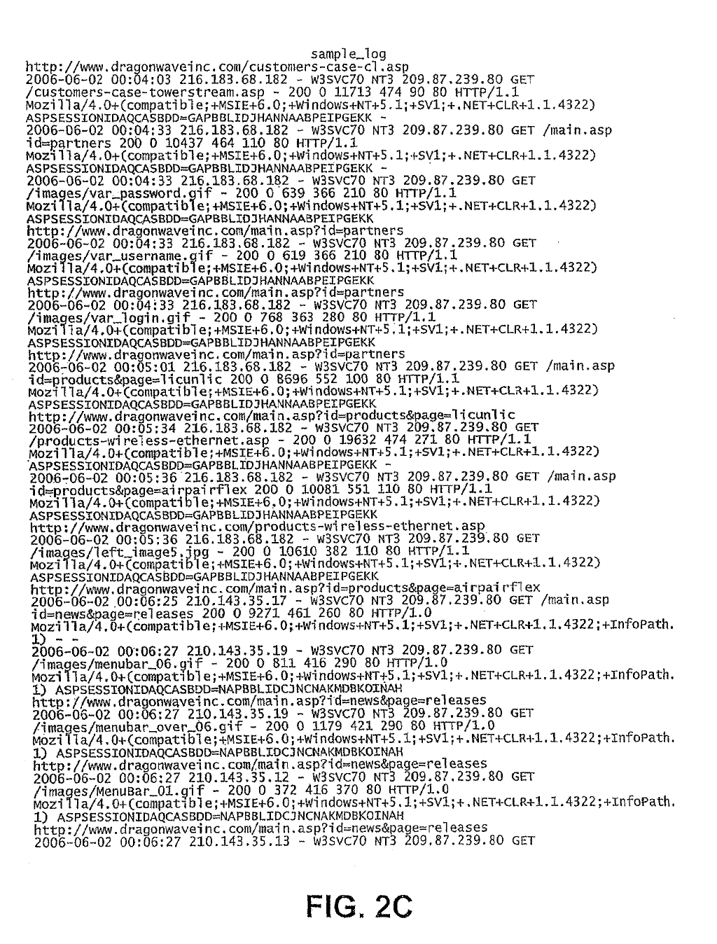

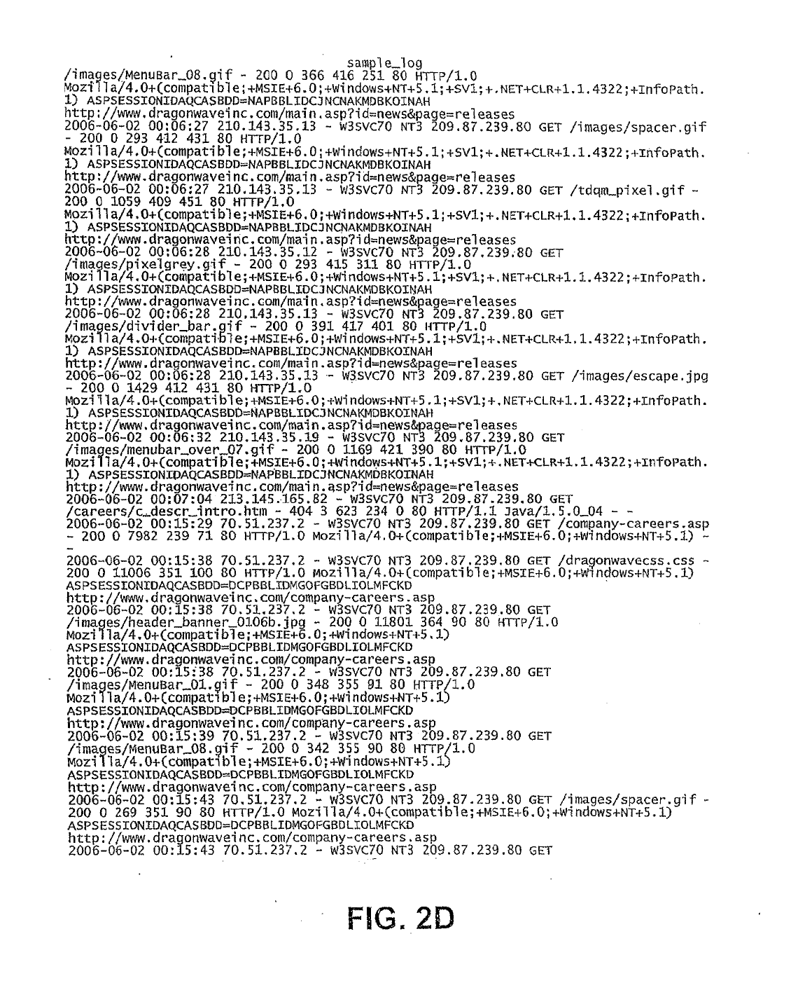

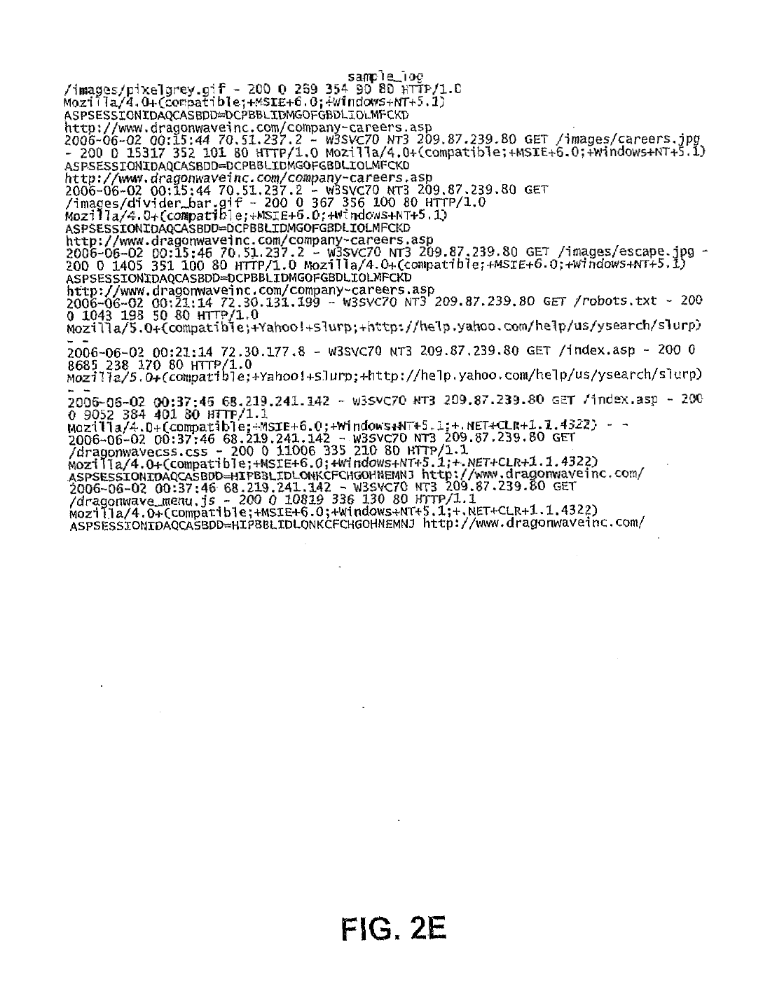

The format of log data entries, which is also entirely conventional, may be seen in an example log in FIG. 2. The web saver log data file is conventionally stored as an ASCII text file, preferably in comma-separated value (CSV) format. The log data entries will differ depending on the availability of information in the log data file, as configured by the server administrator (not shown).

Typically, where an individual visitor directly accesses the web-site, the log data entry records multiple variables, among which typically include the IP address, the user agent, the page viewed, the time and date that the page was accessed and a status field, which reflects an error-free access (code 200) or else an error code (for example, error code 404: page not found), etc.

In other circumstances, the visitor may have employed a query in a search engine and the web-site under scrutiny 105 was turned up in the results from the search. In such a scenario, corresponding entry in the log data stone 115 will reveal a “reference” and the “search term” entered by the visitor.

In some circumstances, the visitor is not an individual, but rather a software process such as an Internet robot, spider, link checker, mirror agent, hacker, or other such entity used to systematically peruse vast tracts of the Internet 110. The log data entry corresponding to such accesses may display an IP address, host name and/or user agent that may be associated with such entities. For example, “GOOGLEBOT” of ten refers to Google spiders, while the “SLURP” often refers to Yahoo spiders.

The log analyzer 120 retrieves log data from the log data store 115 and conducts analysis on the data, particularly the IP address information, as discussed below. In the course of its analysis, it forwards reverse DNS look-up requests to the internal DNS module 125 for processing, accesses filter information from the filter configuration store 135, and then outputs the analyzed data to either the visitor database 145 or the remainder bin 140.

In general, the log analyzer 120 attempts to affiliate the IP address and/or host name of each log data entry to one of a plurality of stakeholder categories of interest to the web-site 105, by creating an association between the IP address and/or domain name information of the visitor exemplified by the entry and one of the enumerated categories. If it is unable to affiliate the visitor corresponding to a log data entry with one or more of the identified stakeholder categories of interest, the log analyzer 120 relegates the entry to the remainder bin 140 for later processing by the filter updater 150.

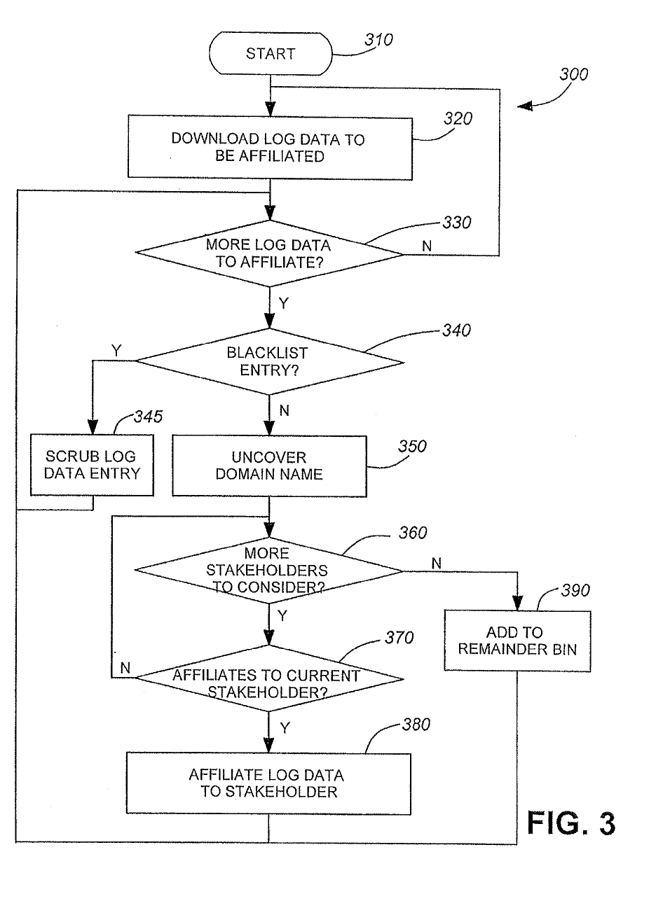

The processing performed by the log analyzer 120 to perform the affiliation of each log data entry is shown in an exemplary flow chart in FIG. 3.

Upon startup 310, the log analyzer 120 downloads 320 a number of log data entries from the log data store 115 for affiliation. It then handles each downloaded log data entry in turn 330. Those having ordinary skill in this art will readily appreciate that this infers a batch mode of processing. Such batch processing may be periodic or intermittent and may encompass any suitable time frame, ranging, for example, from overnight downloads of the day's log files to a download of several months or years of data.

Those having ordinary skill in this art will also appreciate that the log analyzer 120 could be configured to operate in an instantaneous non-batch mode by simply having the log analyzer 120 access any unprocessed log data entries remaining in the log data store 115 individually.

As an initial step in this processing, the log data analyzer 120 attempts to determine whether the log data entry corresponds to an Internet Robot, Spider, link checker, mirror agent or other such non-human entity. Such entities generate tremendous amounts of web-site traffic and can significantly distort traffic statistics. The log data analyzer 120 applies a filter representing such non-human entitles to each log data entry, as discussed below in greater detail. If a match is found, the corresponding entry is flagged as non-human entry and processed accordingly. By “scrubbing” the log data of such entities 345, the stage may be set for more realistic, precise and effective web-site analysis. Without such corrective action, the actual data may be significantly compromised or would produce suspect results.

Additionally, the web-site analysis system 100 may be configured to include or exclude by this step, visits from entities associated with the web-site under scrutiny 105 itself, such as employees of a company which owns and/or operates the web-site under scrutiny 105

In either scenario, there are two options for dealing with such data. First, such data could be completely deleted, so that there remains no trace of its existence. Second, and alternatively, such data could be merely recognized and segregated, as in a greylist stakeholder, so that while it will not skew or slant the results of the demographic analysis, the log data entries are nevertheless retained within the visitor database 145. This latter option may be appropriate in situations where useful information may be gleaned from these greylisted log data entries, such as understanding how internal employees and partner entities use the web-site.

During the data scrubbing, preferably on a line-by-line basis, the log data analyzer 120 attempts to map the IP address to a domain name 350. A number of methods are known in the art to provide such a mapping. Perhaps the most common is by a reverse domain name system (DNS) lookup operation. The external DNS module 130 is an on-line process accessible through the Internet 110, whereby an IP address is provided as an input and a corresponding domain name, if any, is returned.

Because each reverse DNS lookup operation takes a finite amount of time, and each log data entry in the log data store 115, which may contain numerous records, undergoes such an operation, preferably the log analyzer 120 does not directly access the external DNS module 130, but rather the internal DNS processor 125.

The internal DNS processor 125 maintains an internal cache of previous reverse DNS lookup requests and the answers returned.

In this way, given that typically, a given visitor will access more than one page, considerable time savings may be achieved by making use of the internal DNS processor 125.

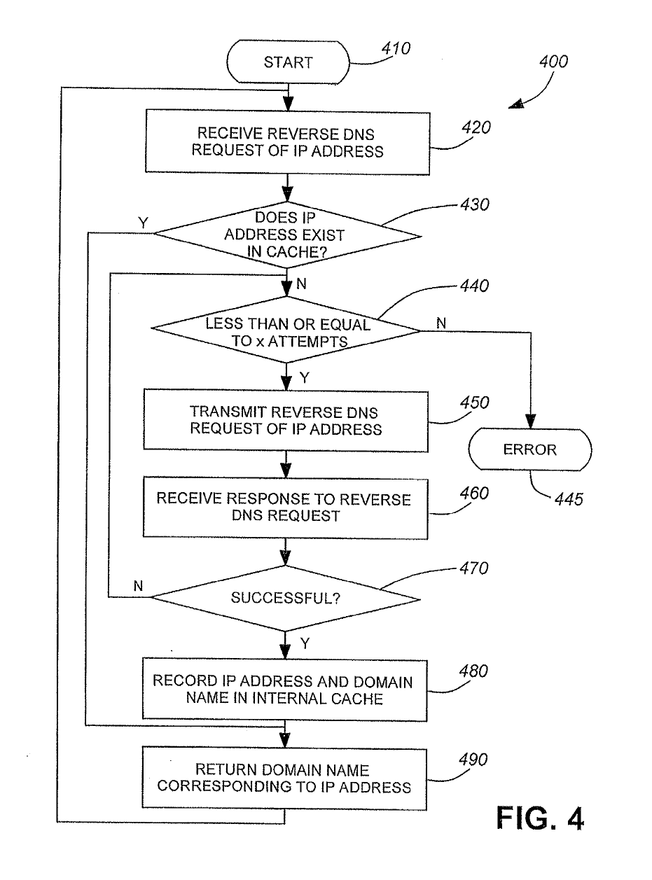

The processing of the internal DNS processor 125 may be shown in exemplary format in FIG. 4. After it has started up 410, when it receives a request 420 for a reverse DNS lookup operation on an IP address from the log analyzer 120, it first checks to see if the same IP address had been previously submitted 430 and if so, returns the corresponding domain name 480 without actually making a request to the external DNS module 130 along the Internet 110.

If, however, the IP address provided to it does not appear in the cache, the internal DNS processor 125 then frames a request to the external DNS module 130 for it to conduct a reverse DNS lookup 450. The external DNS module 130 will either return the domain name corresponding to the specified IP address or signal an error condition, either by returning an error code 460 failing to return a domain name, or returning the IP address provided to it.

If an error code is returned 470, the internal DNS processor 125 may repeat the request to the external DNS module 130 a certain pre-determined number of times, such as 3 440, against the possibility that the external DSN module 130 may not immediately respond, connection failures on the web, server connection or other potential bottlenecks may occur. If, after this number of unsuccessful DNS attempts, no further attempts are made and an error condition 445 is signaled to the log analyzer 120. In such an instance, the log analyzer 120 proceeds to attempt to affiliate the log data entry using only the information available to it from the log data entry itself.

Otherwise, the internal DNS processor 125 records 480 in its cache the IP address and the corresponding domain name returned and returns 490 the domain name to the log analyzer 120.

Once the log analyzer 120 has attempted to uncover a domain name for the log data entry 350, whether or not successful, it applies one of a plurality of stakeholder filters 360 stored in the filter configuration store 135 to the entry 330.

Preferably, the stakeholders are identified according to affiliation, which is more preferably an industry affiliation that may be, for example, coordinated with or drawn from well-known indices of industrial affiliation, such as the North American Industry Classification System (NAICS), its predecessor system, the Standard Industry Classification (SIC) or a sub-category of the so-called MUSH (Municipalities, Universities and colleges, Schools and Hospitals) sector. In such instances, the granularity of the identified stakeholders is generally relatively uniform and fine.

In other circumstances, it may be desirable, or at least more efficient to adopt a less rigorous and detailed set of stakeholders, with a concomitant reduction in granularity. For example, when considering a web-site operated by a department of the US federal government, the set of identified stakeholders may comprise the following: the “at-home” Americans visitor, US municipalities, post-secondary institutions, schools, consulting firms (which may be further sub-divided into human resources, information technology, engineering and management), the environmental sector, elected assemblies, other federal government departments and agencies, state governments and major news media organizations.

However classified, each identified visitor is assigned to a corresponding stakeholder filter, stored in the filter configuration data store 135, for access by the log analyzer 120. Each stakeholder filter is configured to “trap” a log data entry that matches one or more of the filter's constituent criteria and to “pass through” all other log data entries, that is, those that do not match any of its constituent criteria.

Each stakeholder filter is populated with one or more constituent criteria by the filter updater 150. Each of these criteria is conditioned on a single aspect of the log data entry, typically the IP address or the domain name (if any) obtained from the reverse DNS lookup operation 350. However, any other characteristic of the log data entry may be appropriated, such as the date and time of the page access. The constituent criteria are listed in sequential order in each stakeholder filter, in a descending order of preference, as are the stakeholder filters themselves.

In a majority of cases the filter criteria are framed in terms of logical expressions that define whether the IP address and/or the host name match a set of strings, according to certain syntax rules. Preferably, Regular Expression syntax is adopted, although any suitable syntactical expression set or straight text matching may be used.

For example, a filter criterion of:

[symbol]

MATCH=“̂192\.168\. [symbol] (1)

corresponds to a criterion of trapping every IP address between 192.168.0.0 to 192.168.255.255;
a filter criterion of:

[symbol]

MATCH=“\.xyz\.com [symbol] (2)

corresponds to a criterion of trapping any web-site having a domain that contains “.xyz.com”;
while a filter criterion of:

[symbol]

MATCH=“\.ca$

[symbol]

corresponds to a criterion of trapping any visitor having a top-level domain ending with “.ca”, that is, a Canadian company.

The log analyzer 120 thus passes each log data entry through each stakeholder filter in turn 360, until it is ‘trapped’ by a filter 370 or else ‘passes through’ each of the identified stakeholder filters, in which case, the log analyzer 120 relegates it to a remainder bin 390 for processing as discussed below.

If, however, a log data entry is ‘trapped’ by a stakeholder filter, it is considered to satisfy the constituent criteria to be affiliated to the corresponding stakeholder 370 and is stored in the visitor database 145 in association with such affiliation 380.

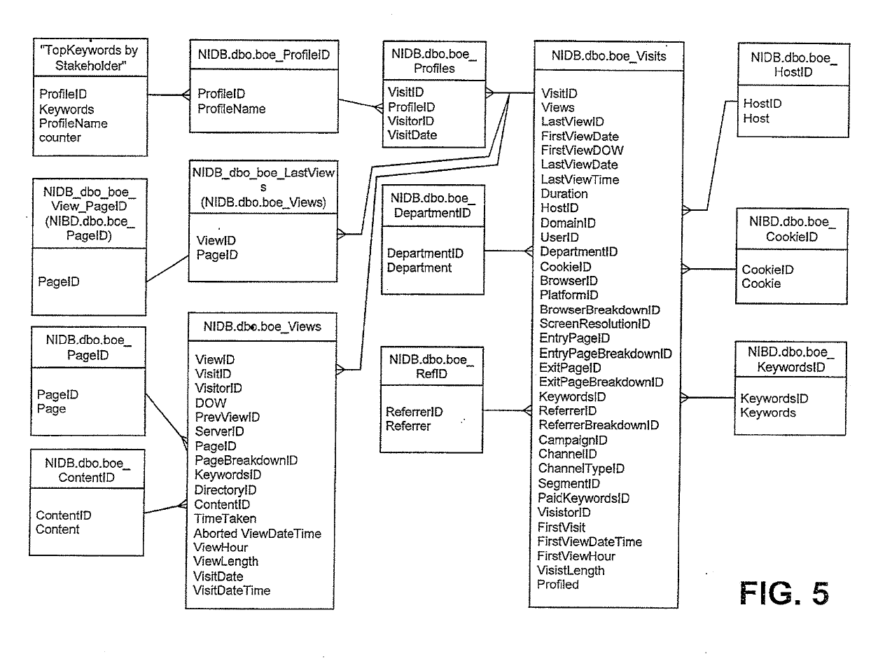

FIG. 5 shows an exemplary database structure that may be suitable for use in the visitor database 145. It identifies the log data entry in accordance with its constituent fields, including IP address, page viewed, time of access and status, as well as additional information associated with it by the log analyzer 120, such as the domain name, if any, and its affiliated stakeholder.

A suitable log analyzer 120 may be Affinium NetInsight web analytics software manufactured and sold by Unica Corporation of Waltham, Mass.

The filter updater 150 generates and/or initializes a series of stakeholder filters from the filter configuration store 135. The log analyzer 120 processes the data and sorts it either into the visitor database 145 if the IP address and affiliations can be resolved, or relegates it to the remainder bin 140 if the log analyzer cannot identify to which of the stakeholder filters it properly belongs.

If it is successful in so doing, it adjusts the corresponding stakeholder filter definition in the filter configuration store 135 and stores it in the appropriate stakeholder category in the visitor database 145.

To accomplish this, the filter updater 150 may have access to the Internet 110 to make use of one or more affiliation lookup modules 165 and/or web-sites 170, as appropriate.

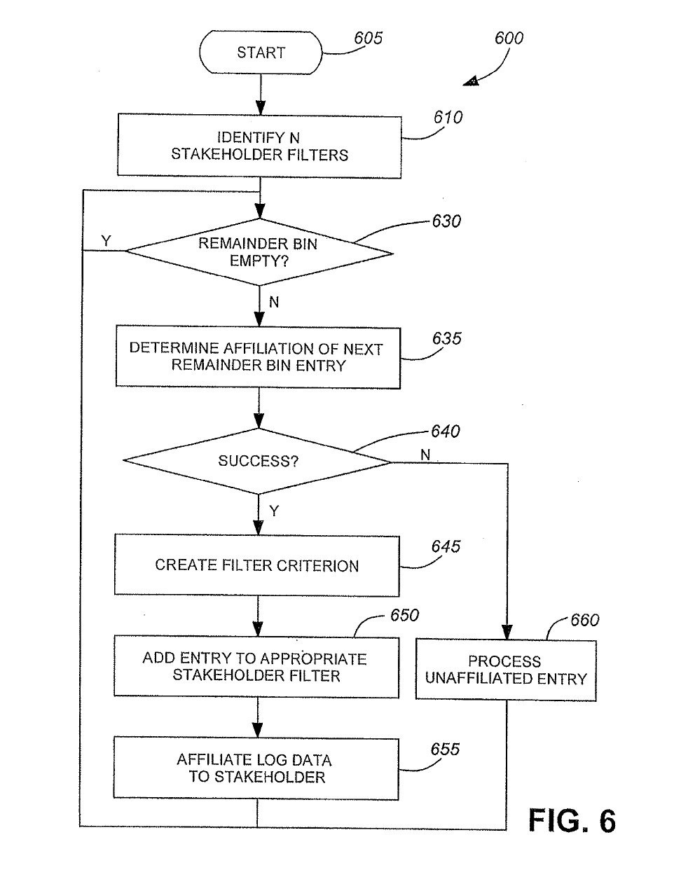

The processing performed by the filter updater 150 to perform these functions is shown in an exemplary flow chart in FIG. 6.

Upon startup 605, the filter updater 150 identifies 610 the number N of stakeholders to be associated with the web-site under scrutiny 105.

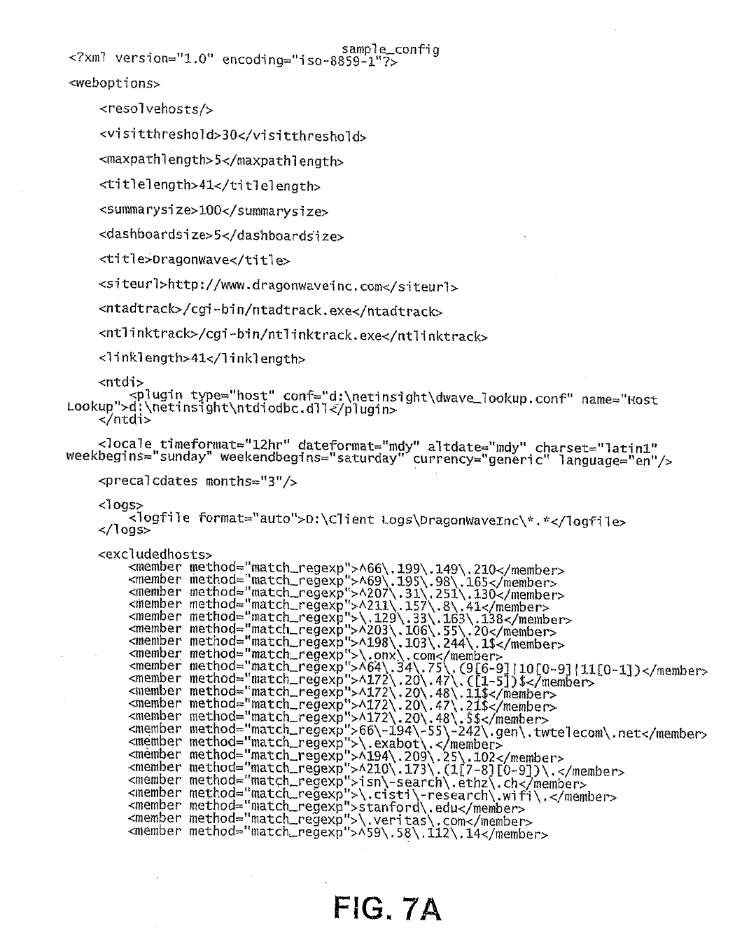

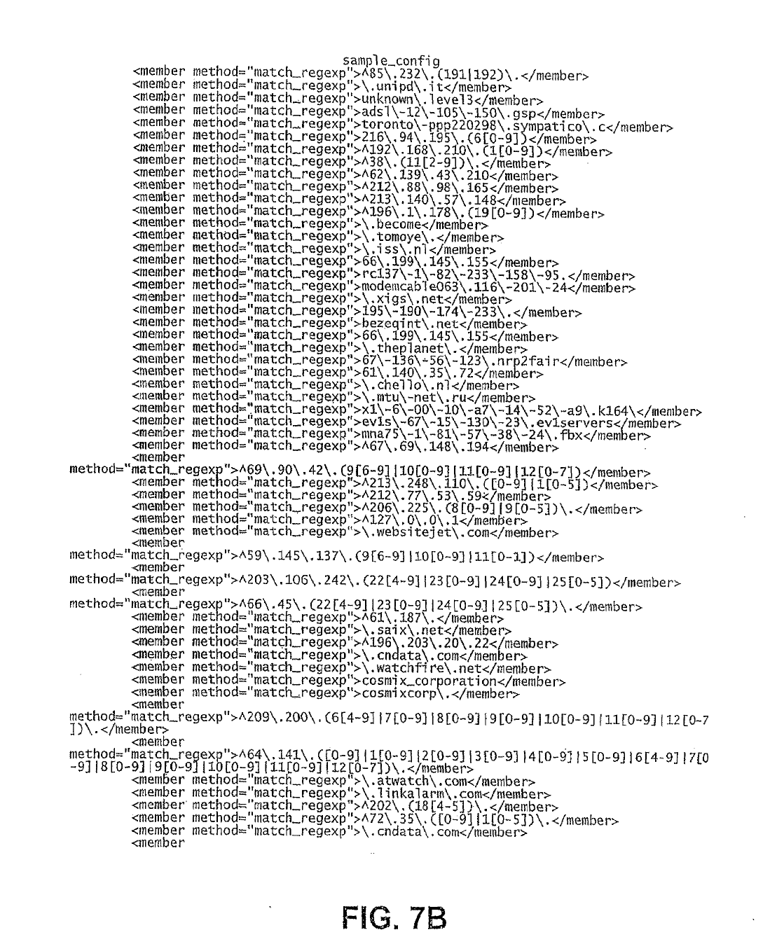

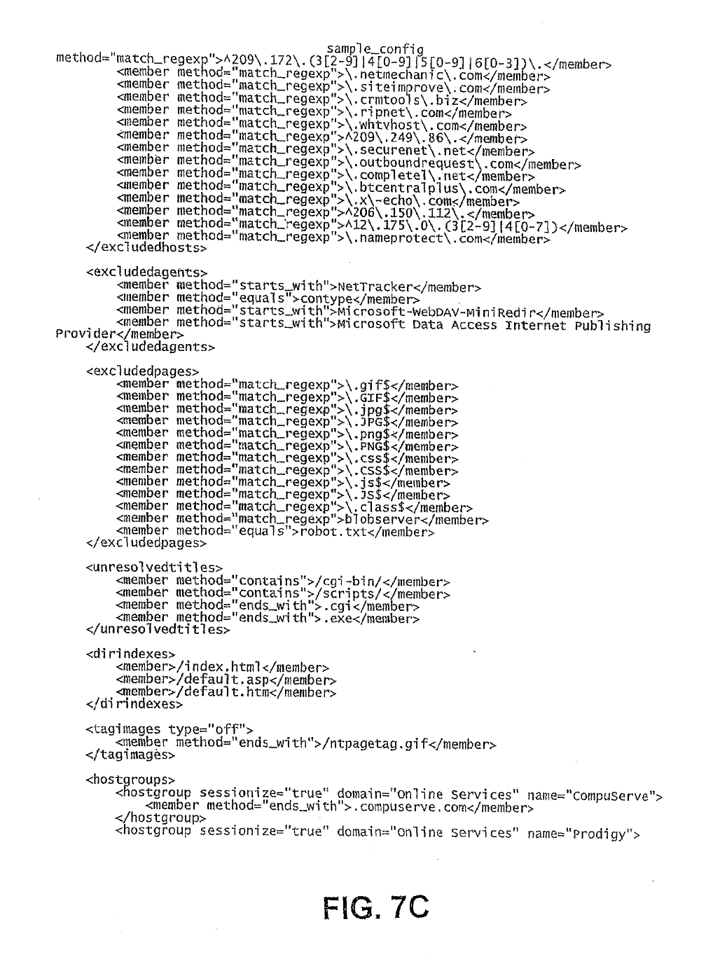

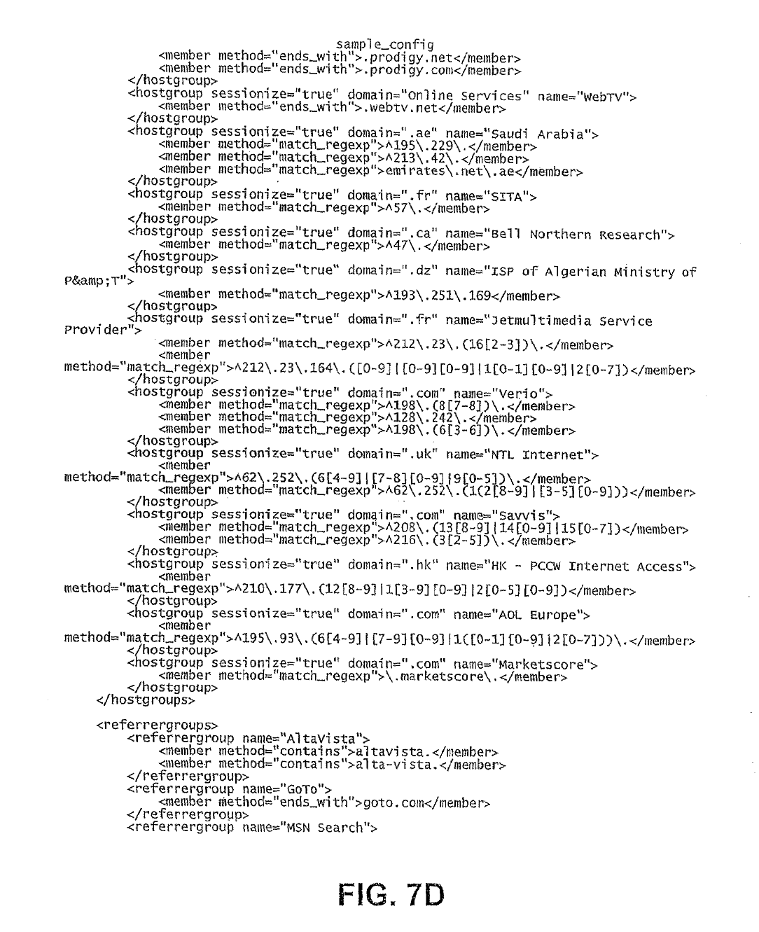

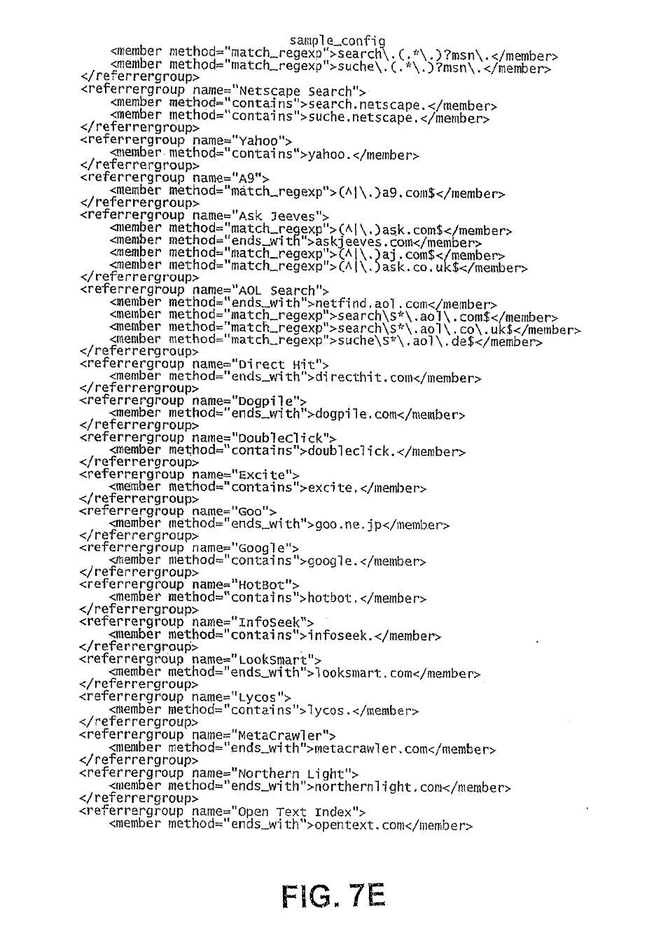

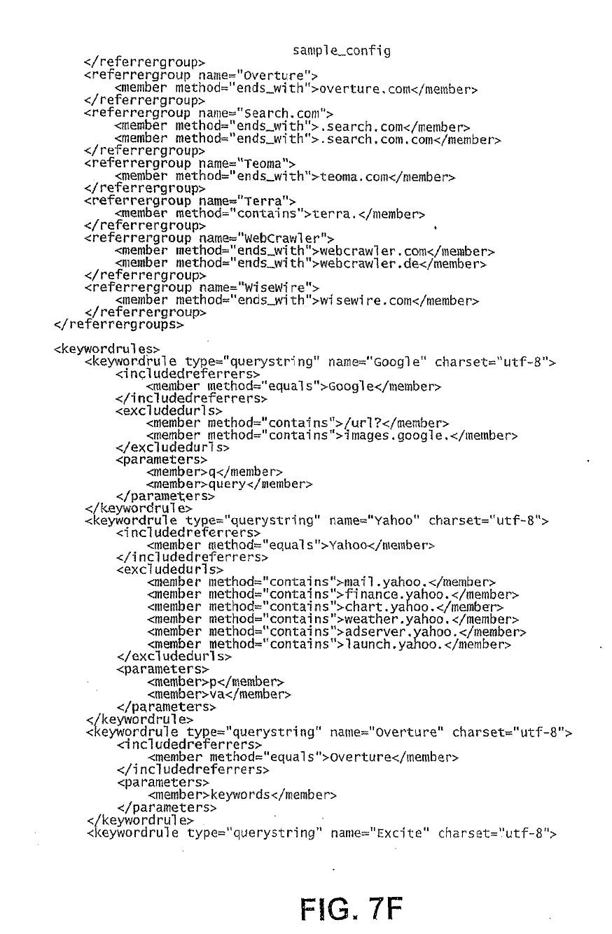

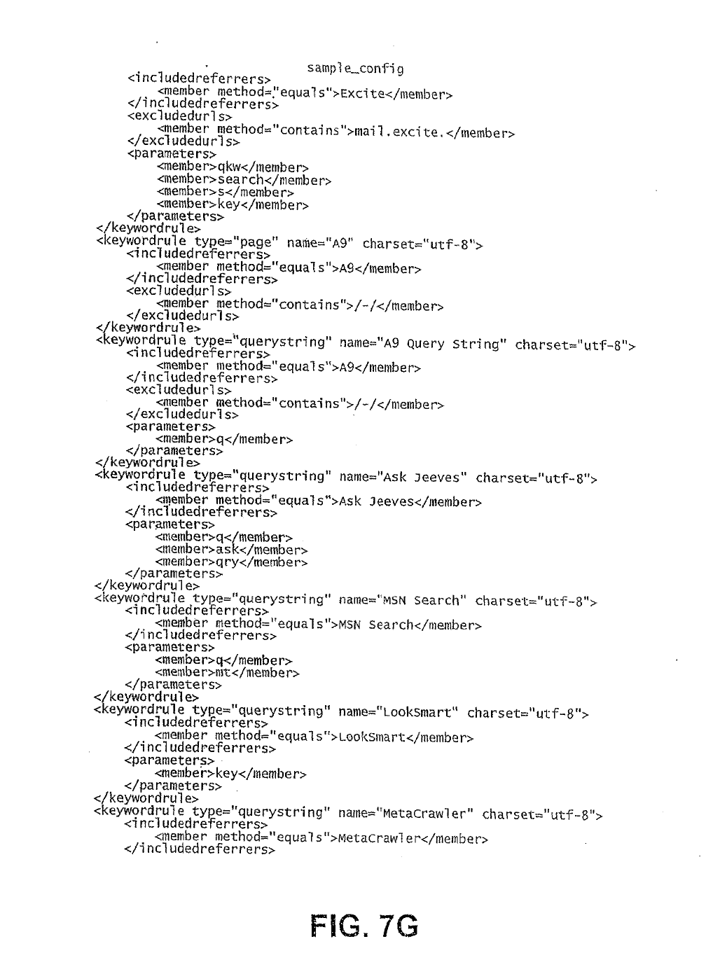

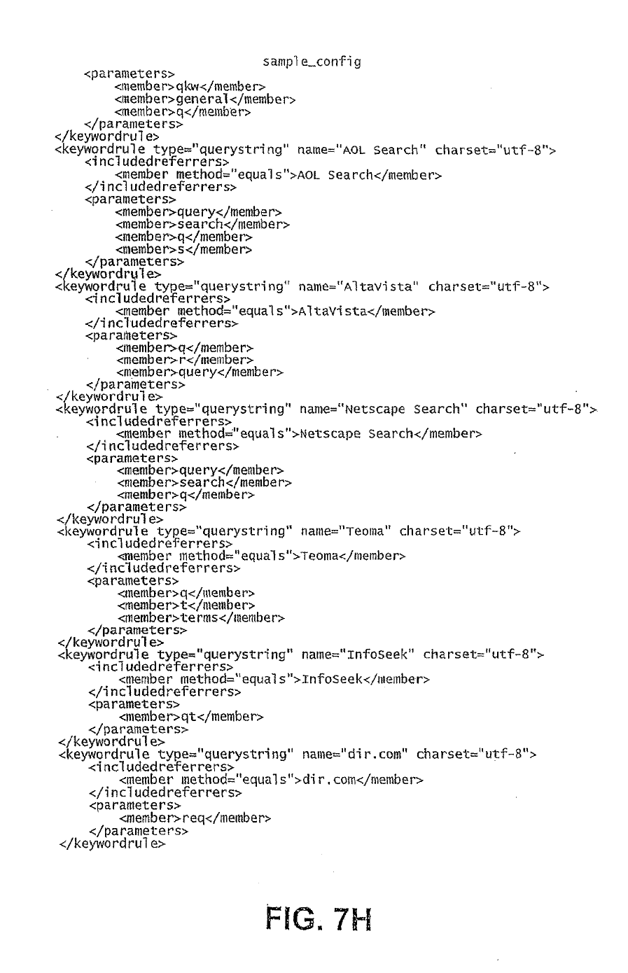

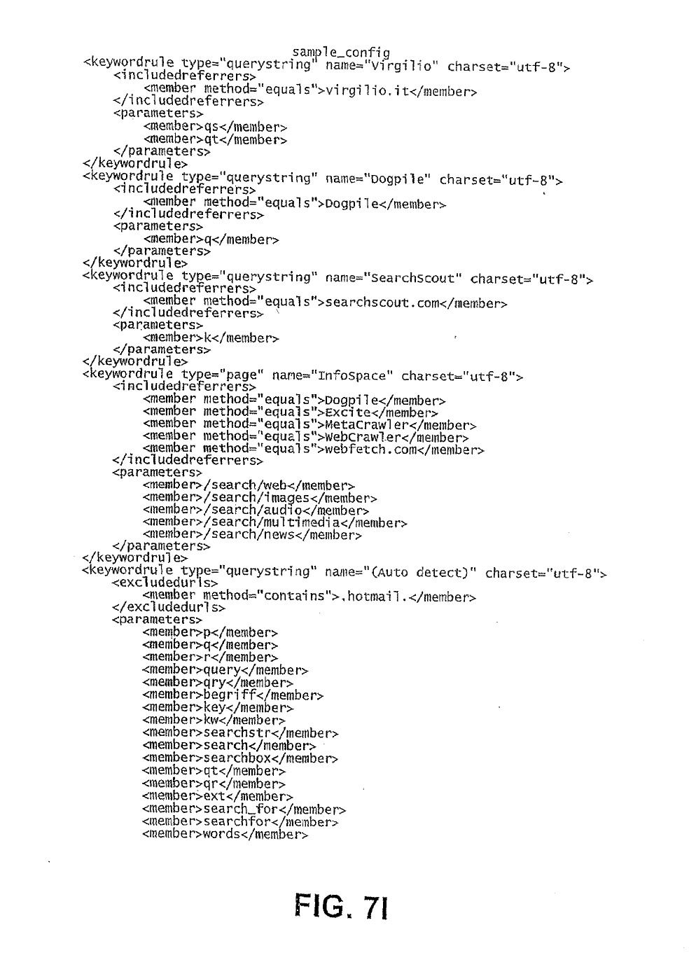

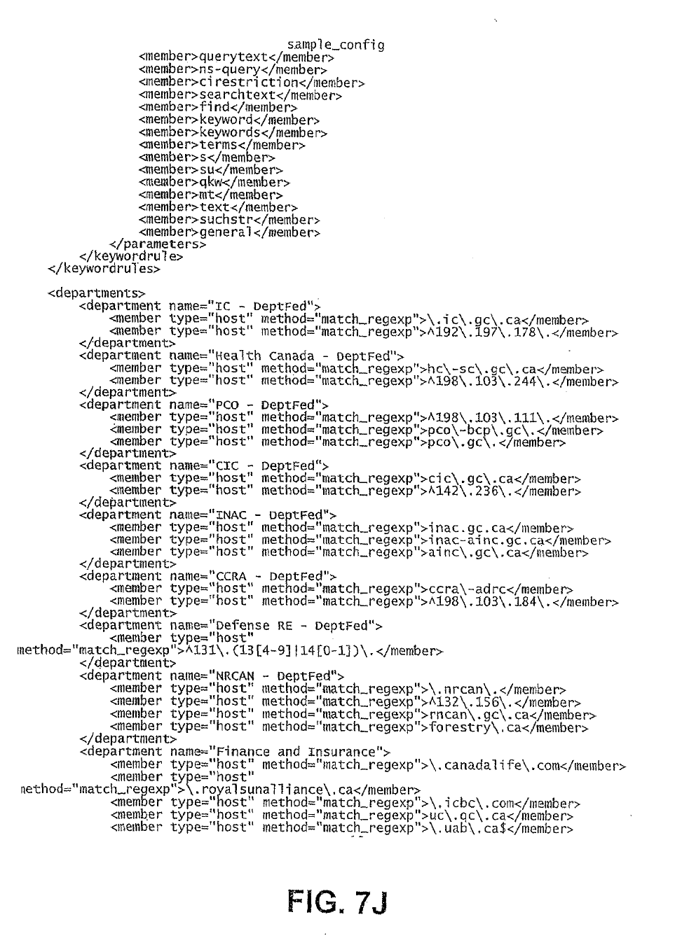

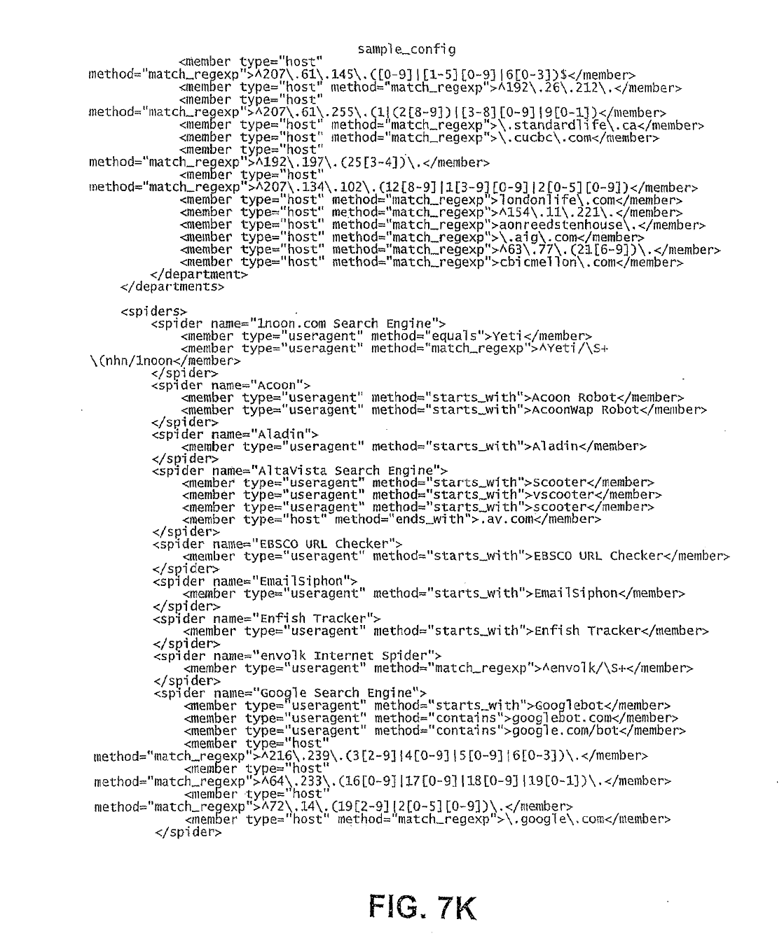

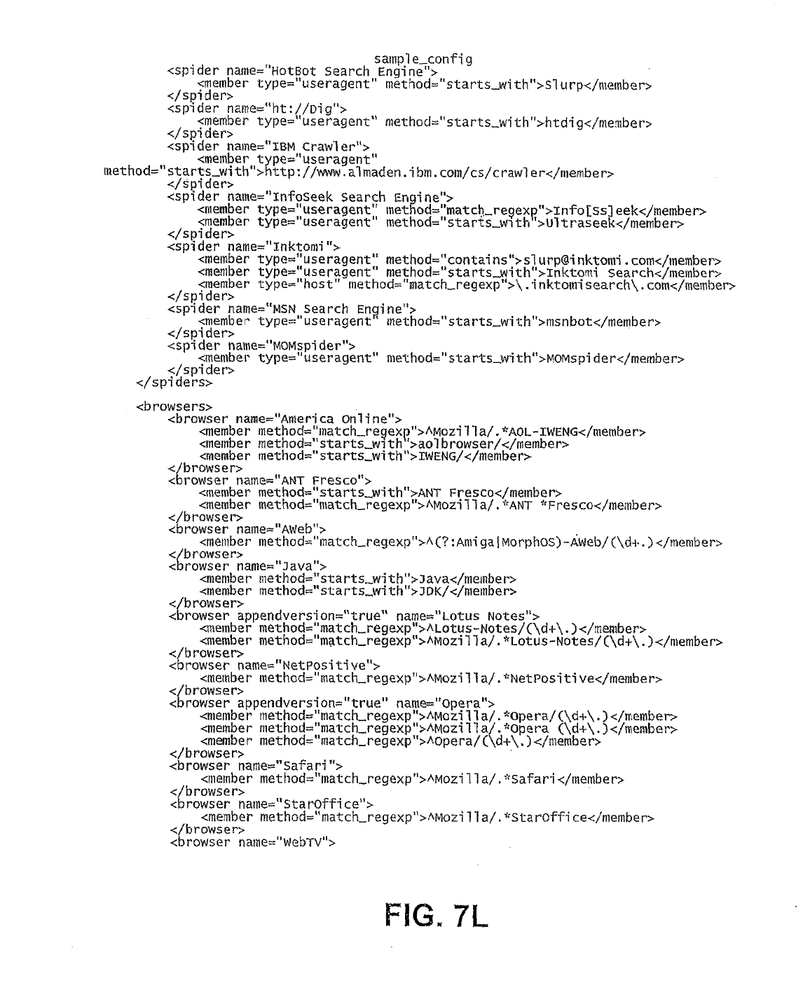

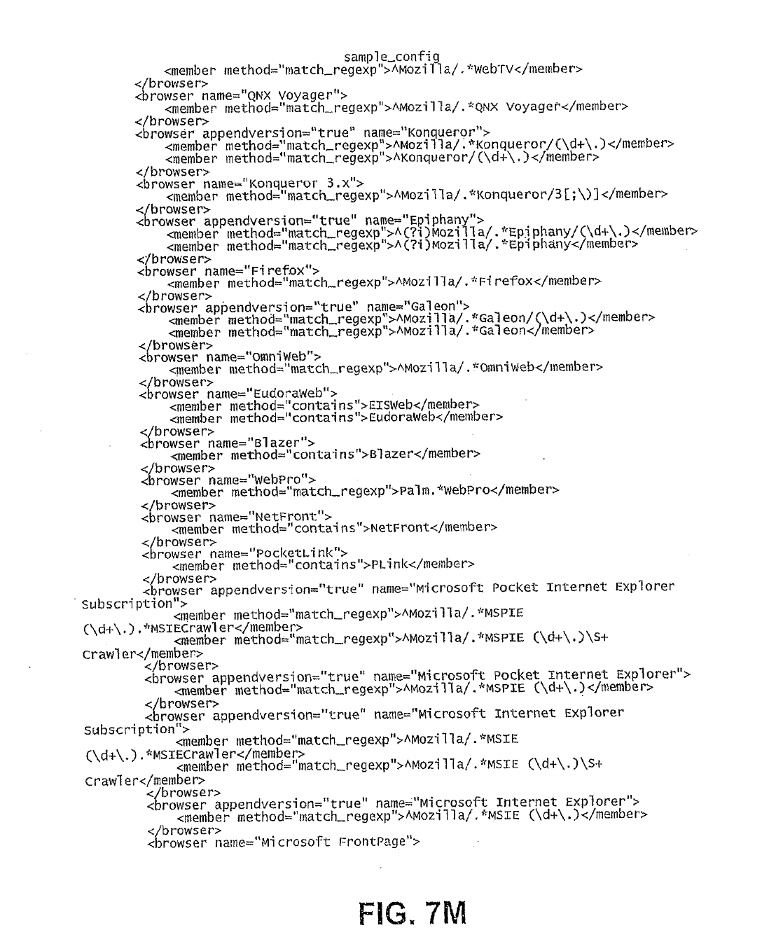

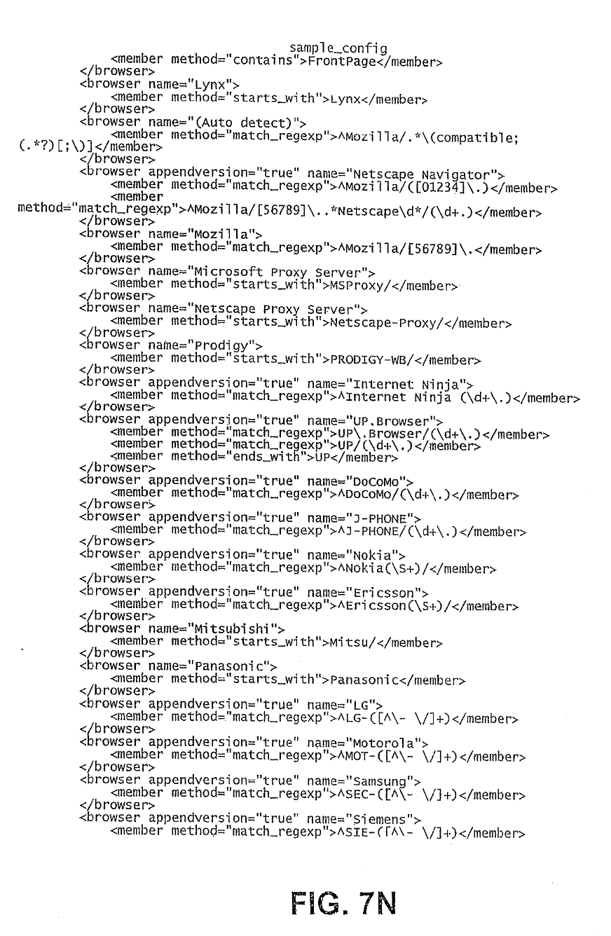

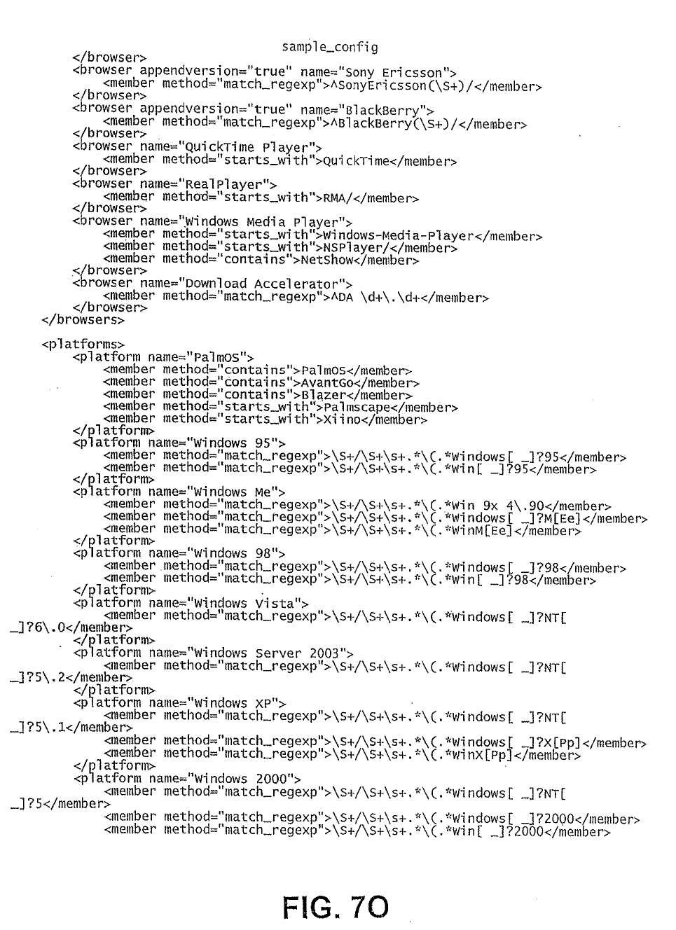

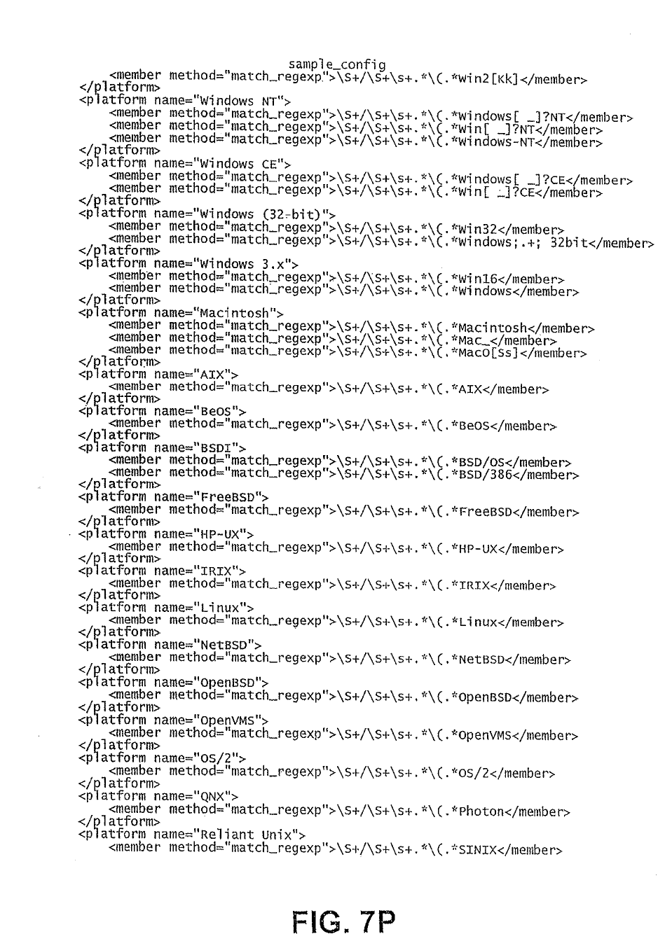

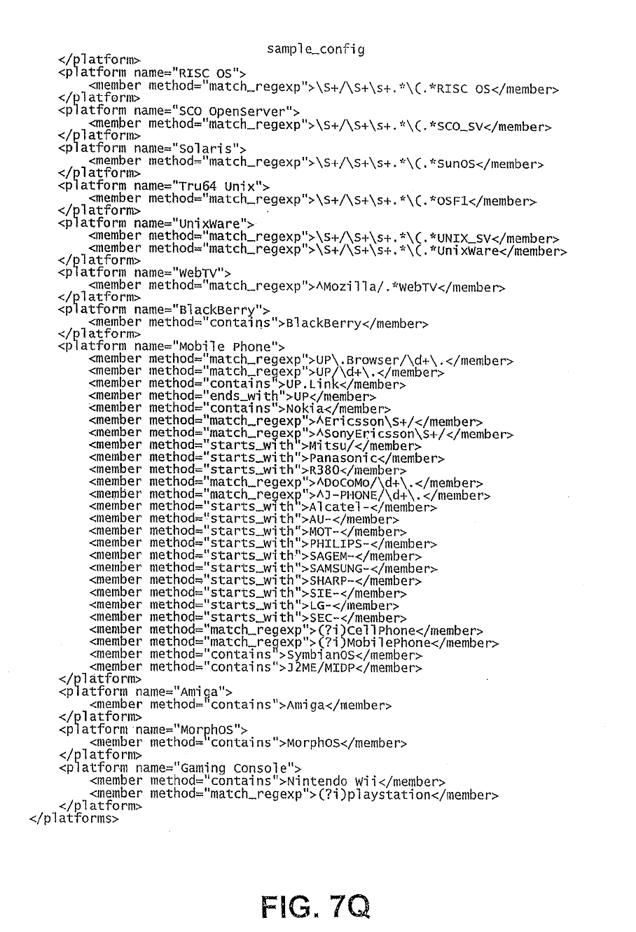

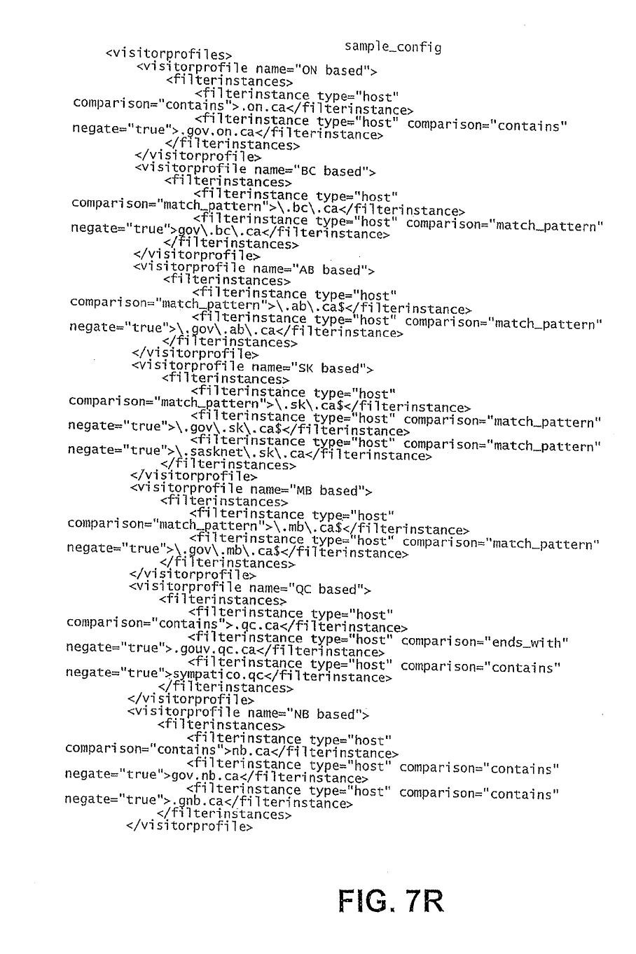

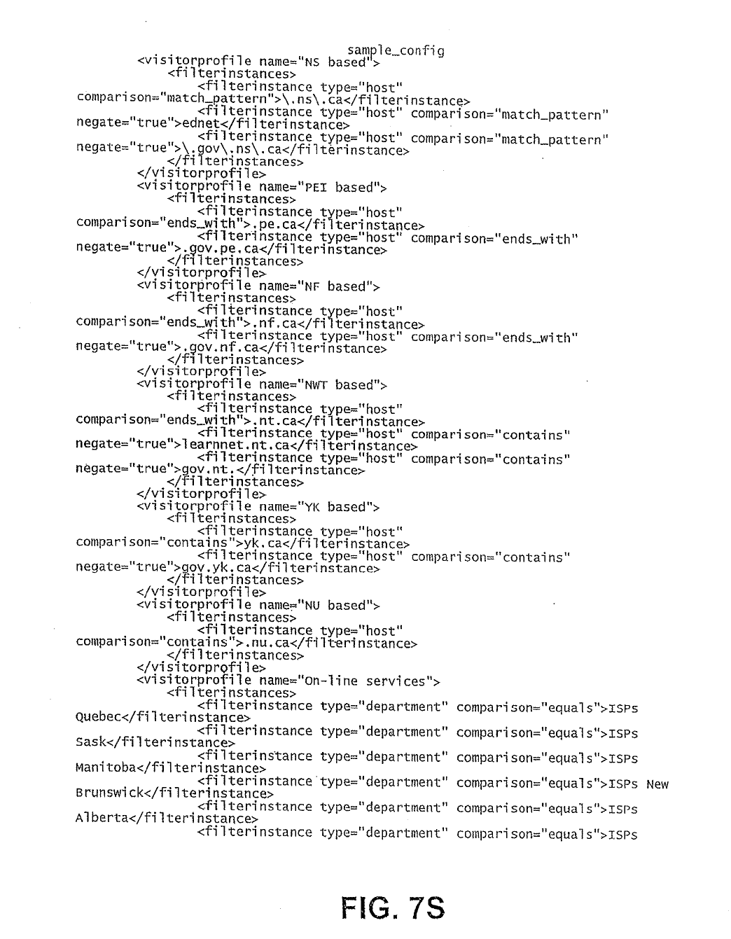

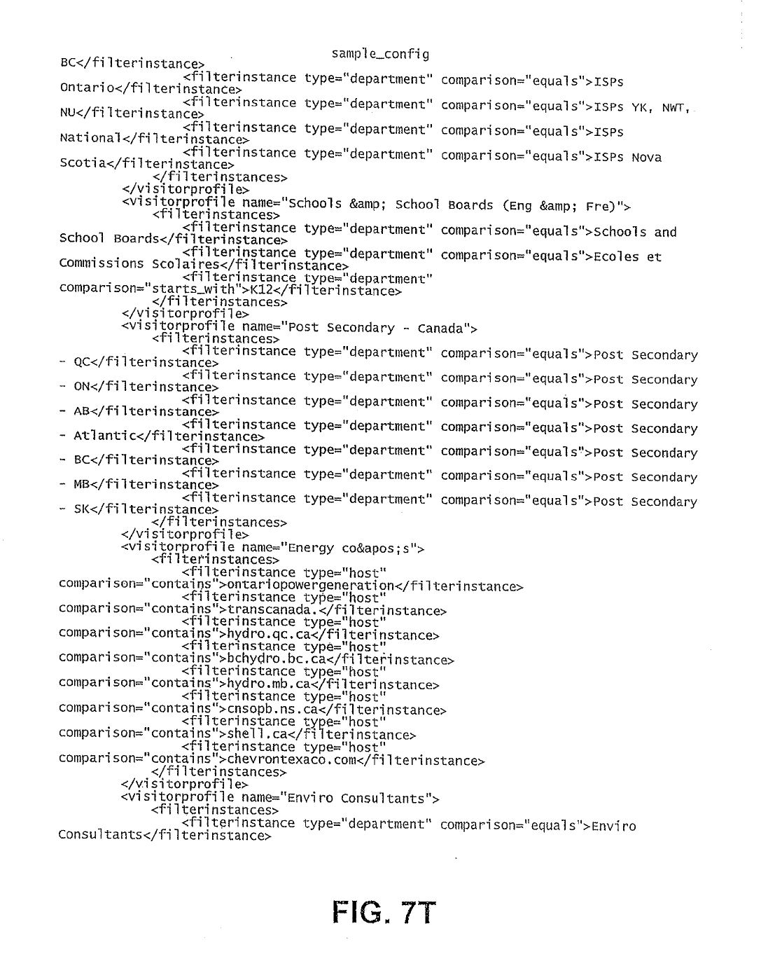

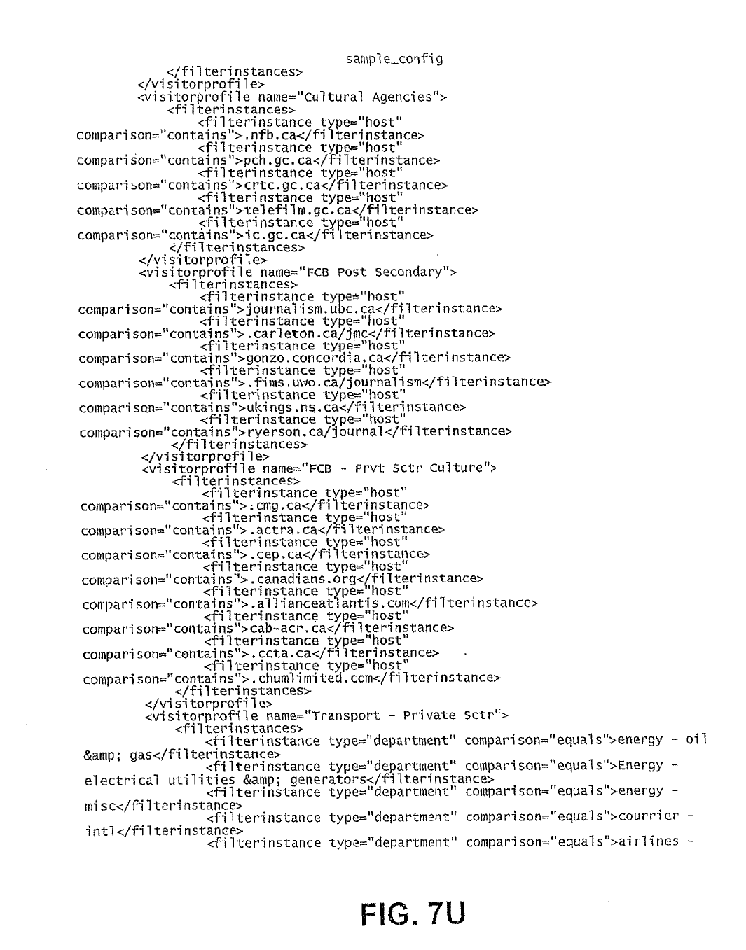

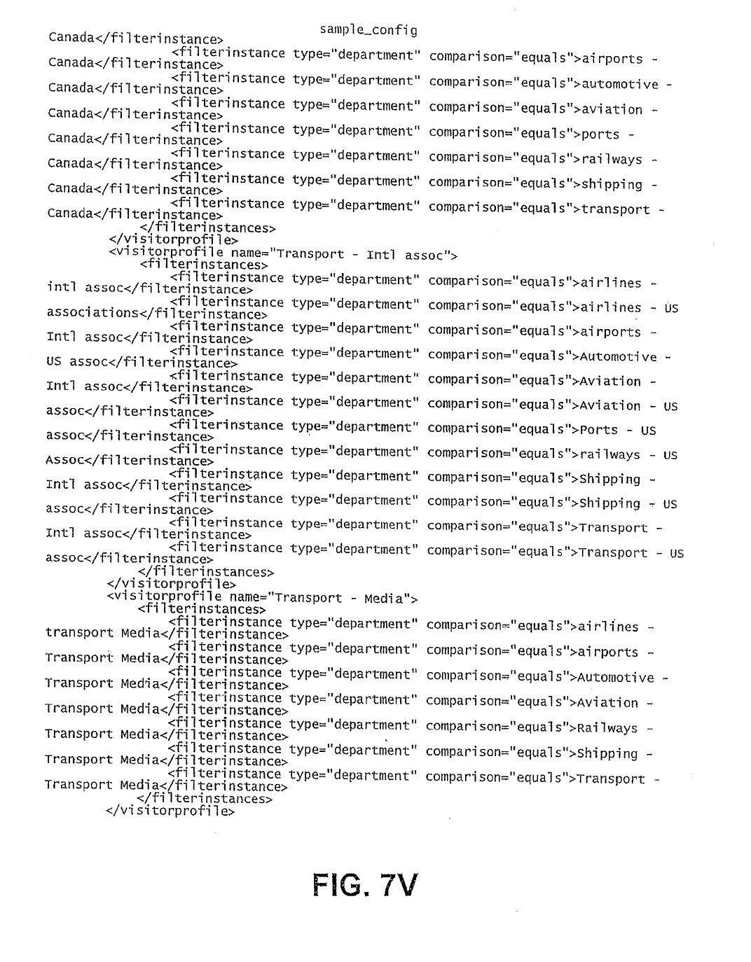

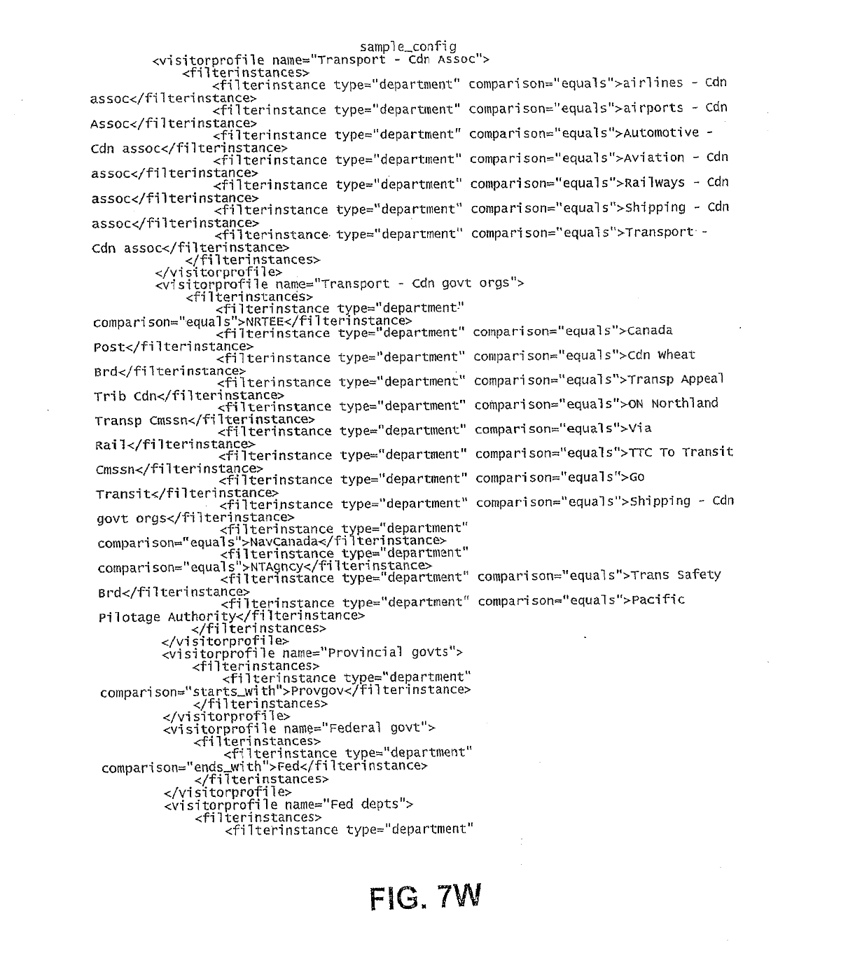

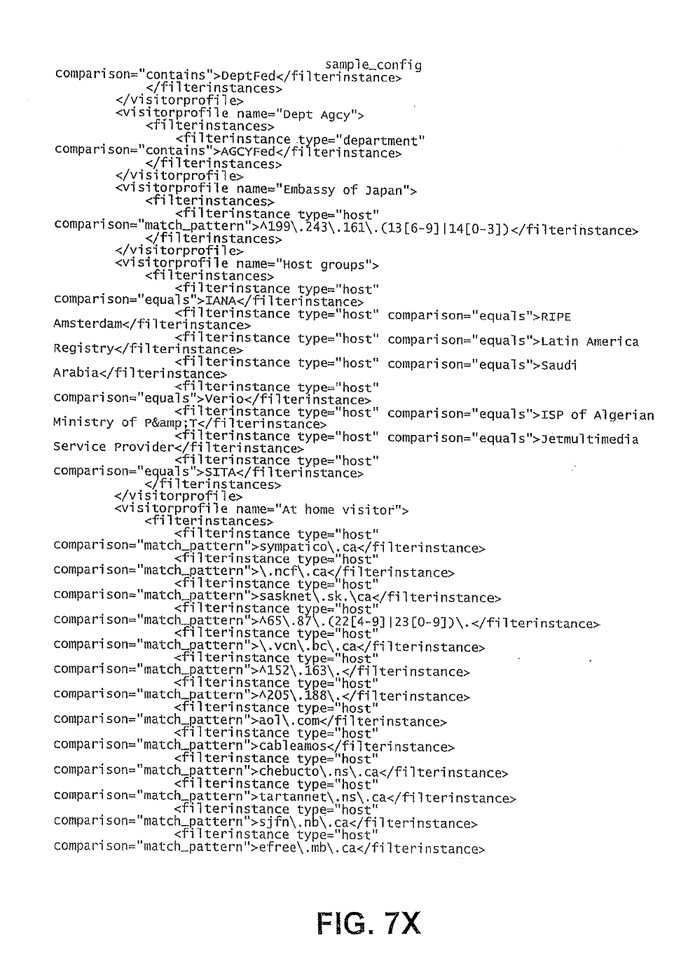

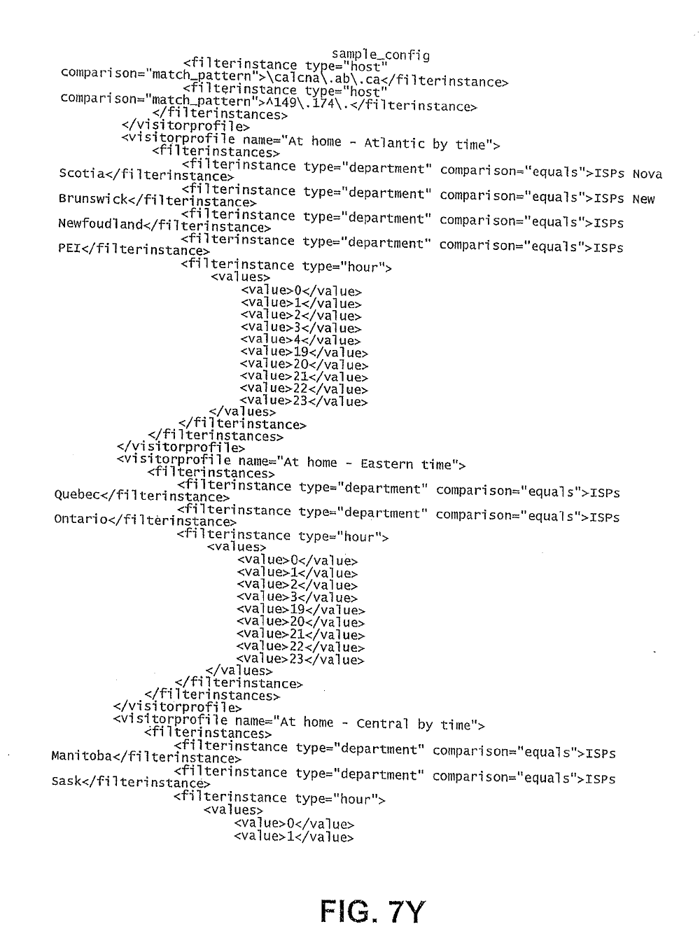

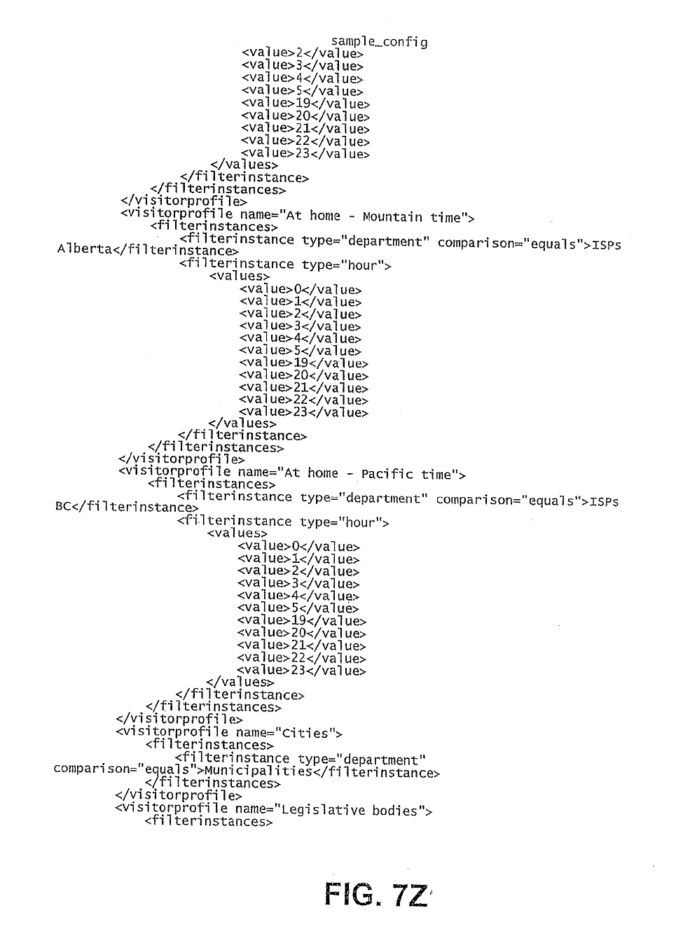

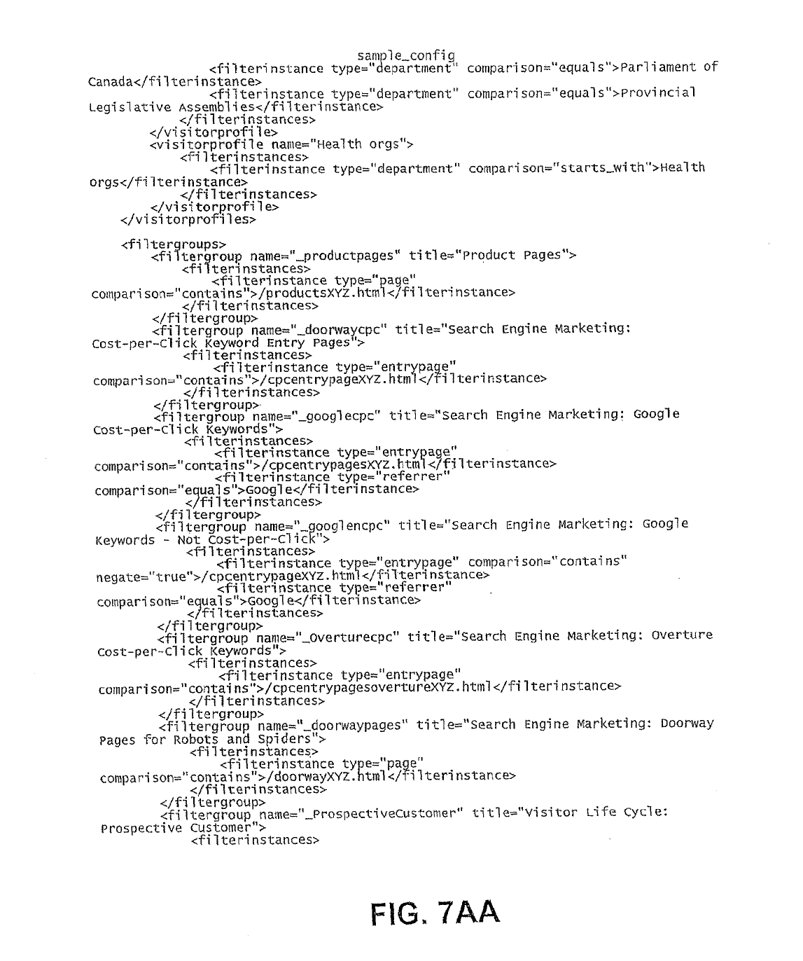

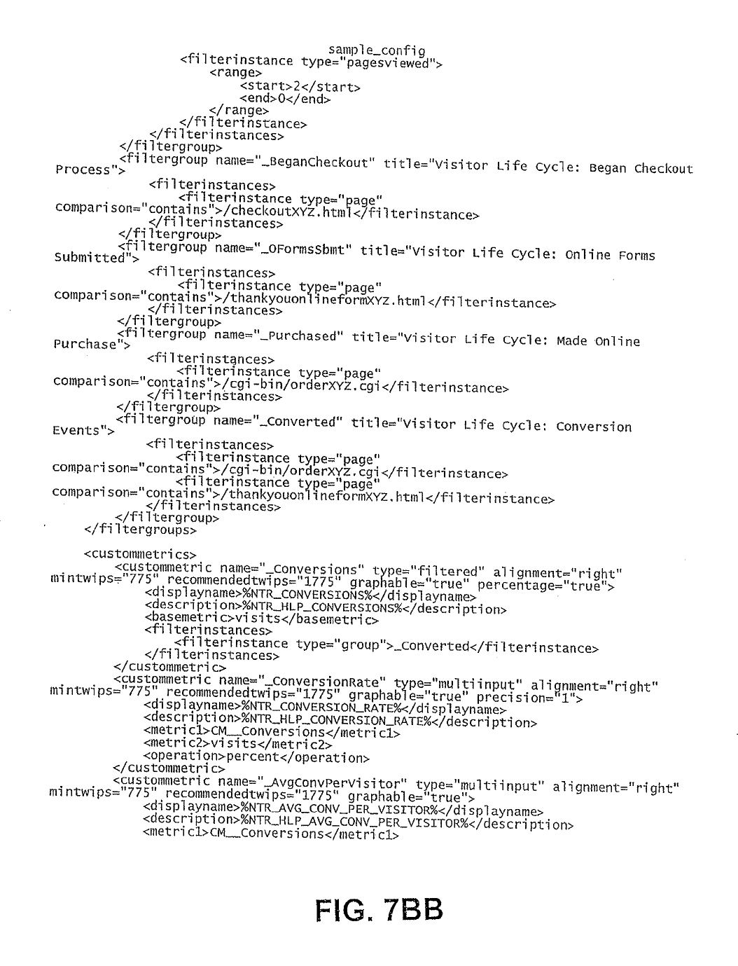

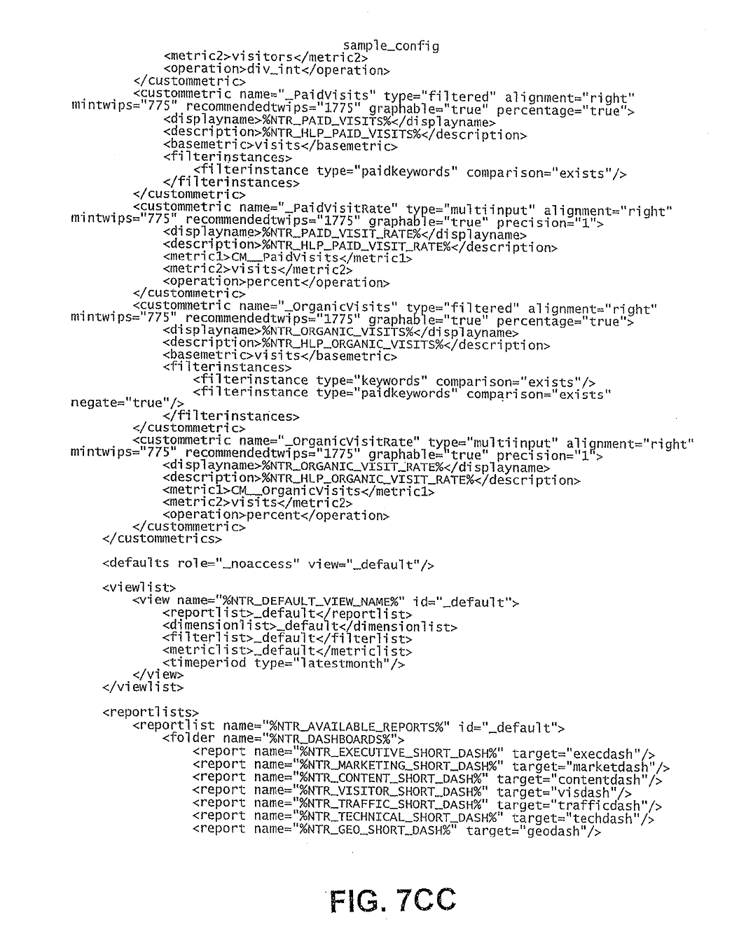

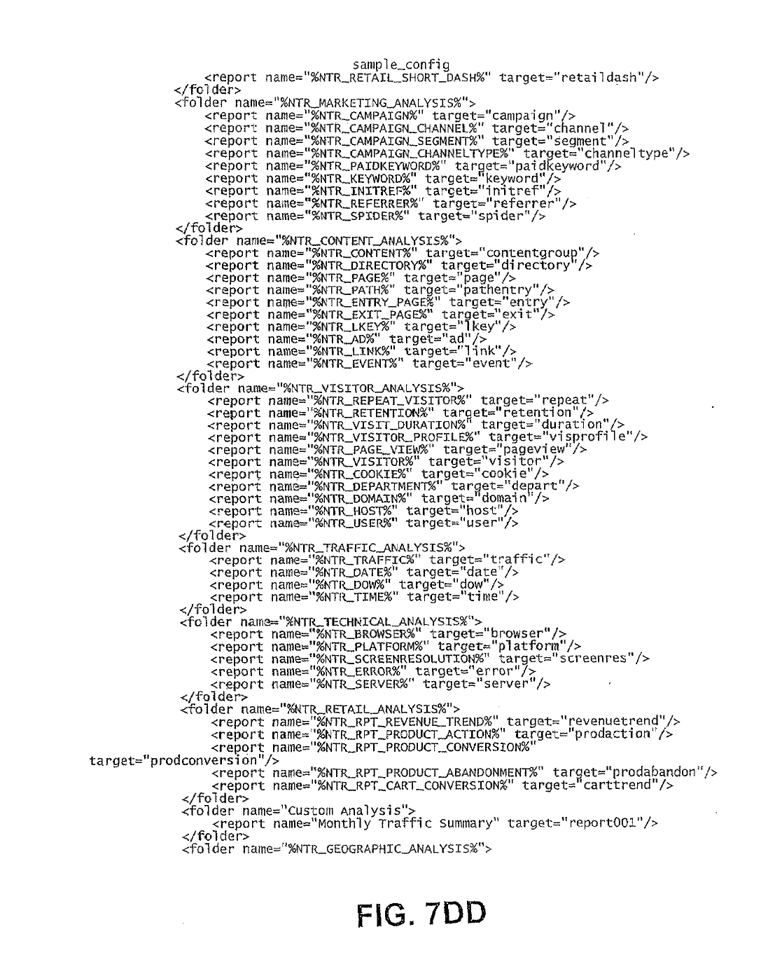

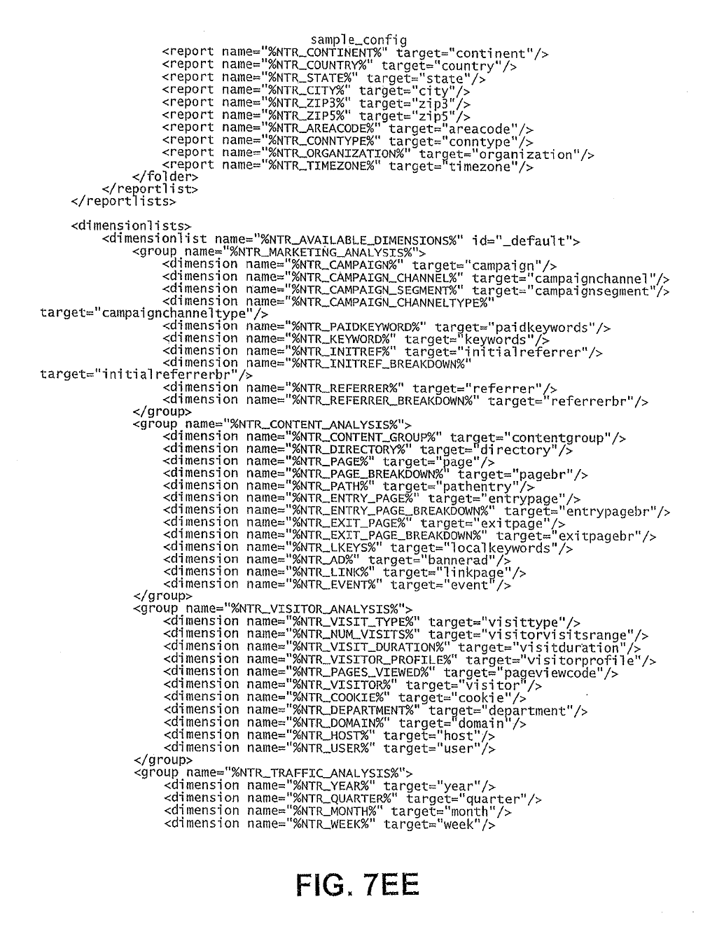

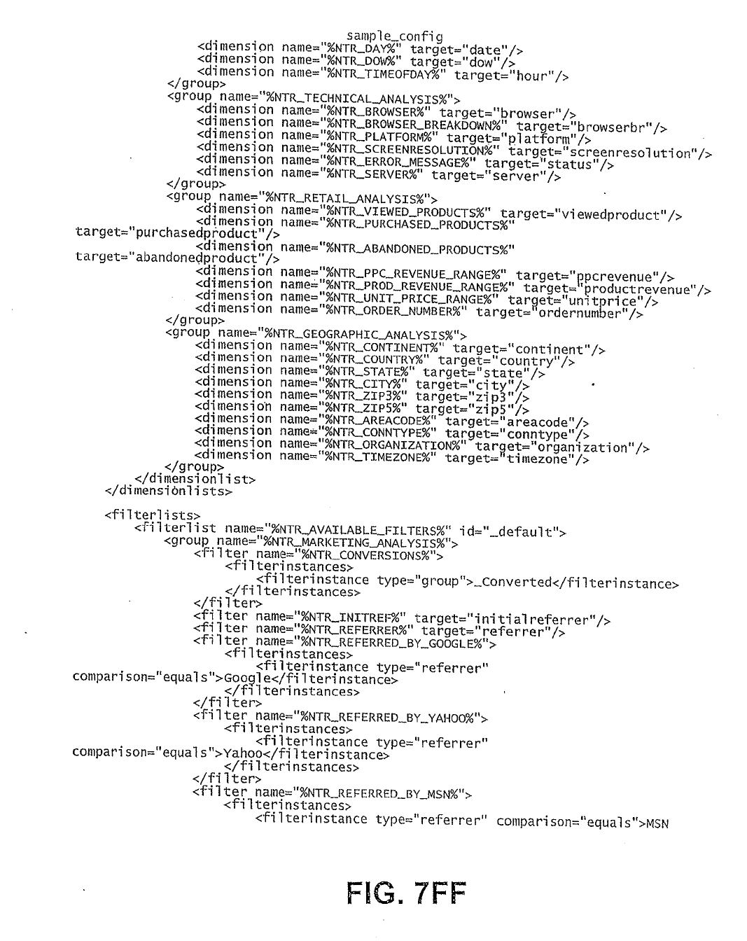

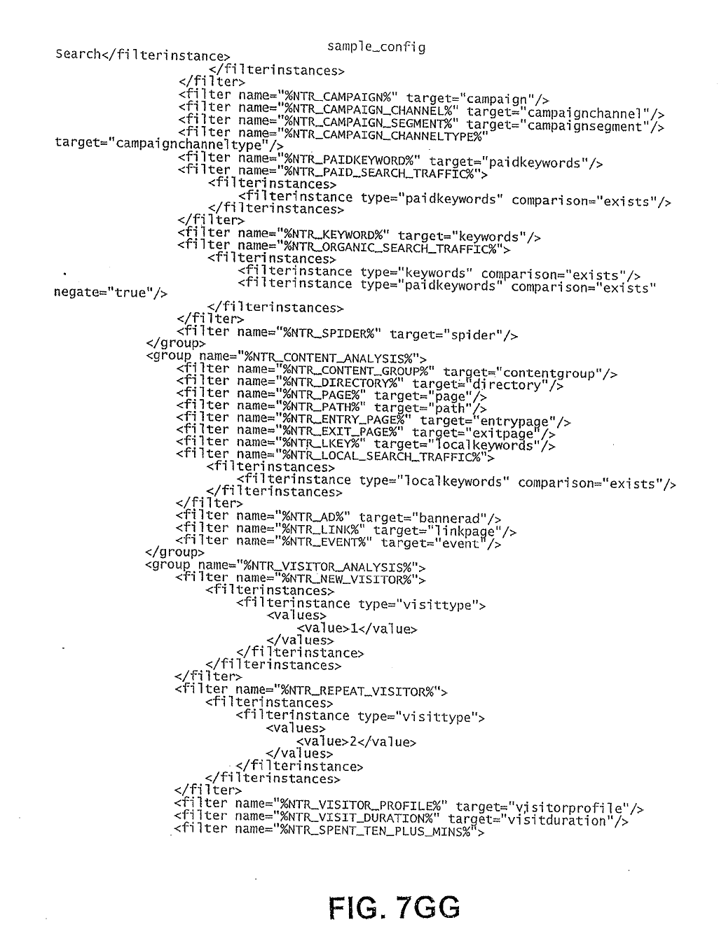

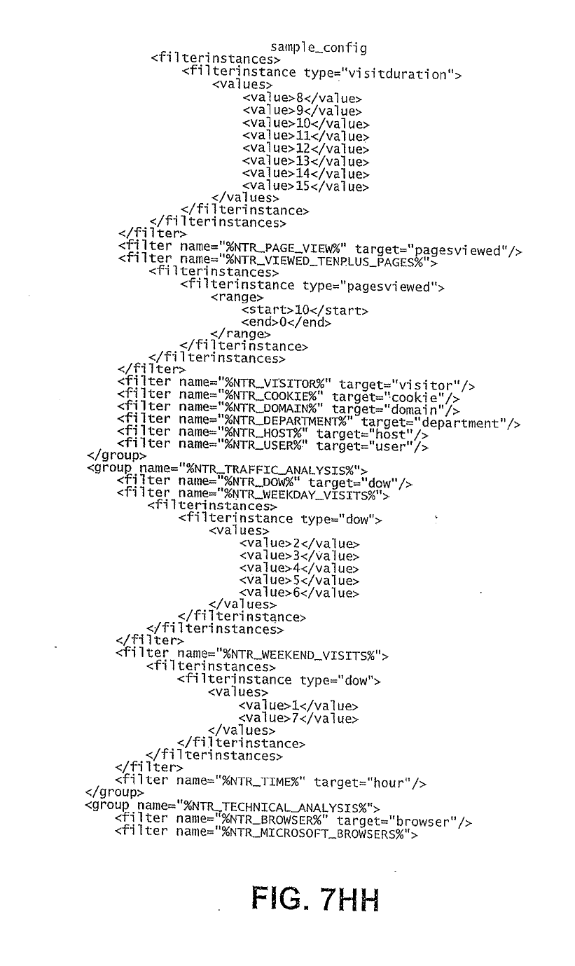

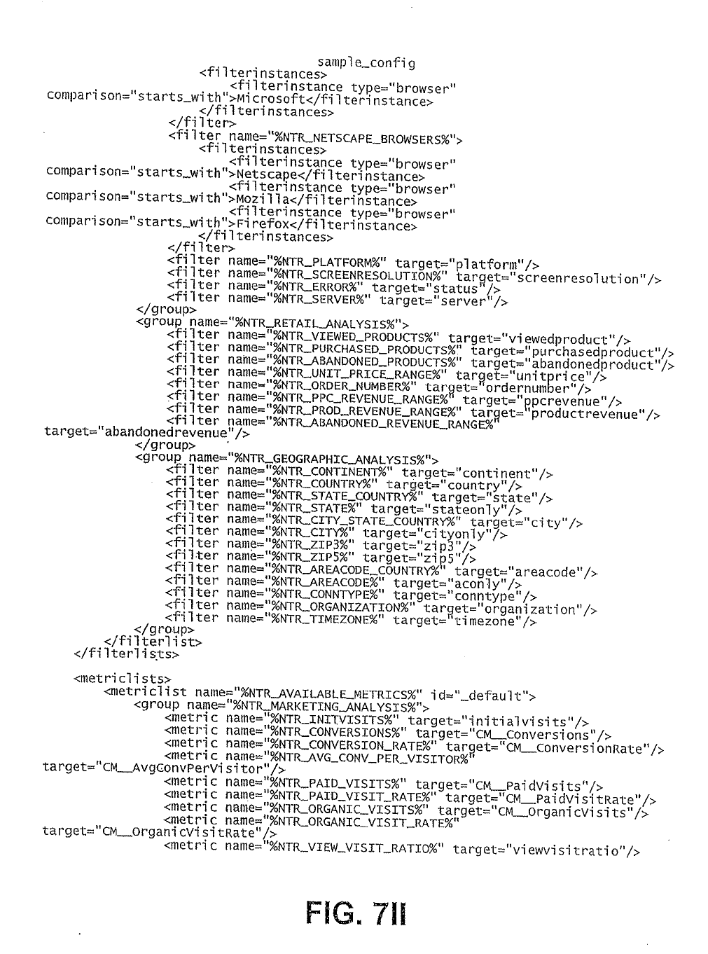

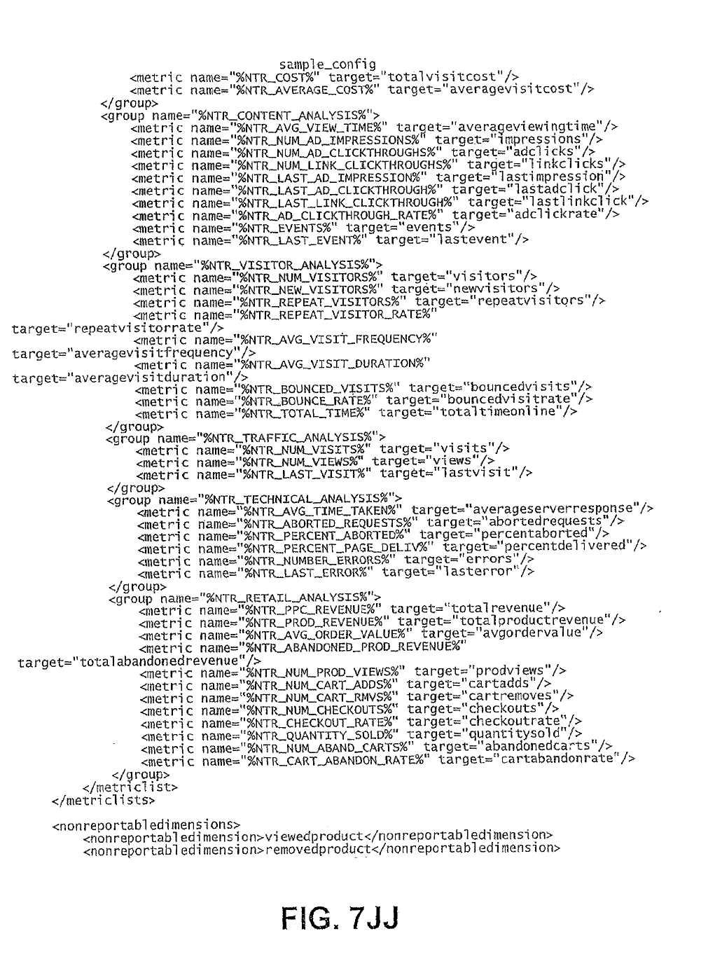

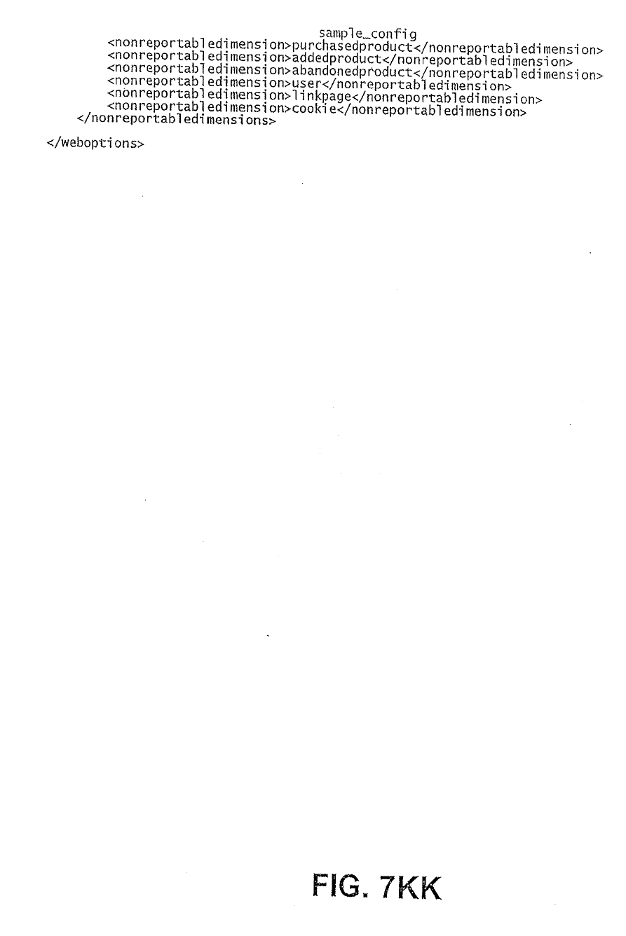

An exemplary format of the filter configuration store 135 housing the various stakeholder filters is shown in FIG. 7. It comprises a list of each stakeholder filter, preferably in descending order of precedence. That is, generally more specific and/or important stakeholders are listed first, followed by progressively more and more general stakeholders. Thus, the log analyzer 120 will attempt to pass each log data entry through the more specific/important filters first, so that the log data entry will be trapped by one of these filters first and not pass through to any of the more general filters.

Each of the stakeholder filters is delimited by a header and a footer. In the illustrated example, the header consists of the text <DEPT NAME “<stakeholder>”>, while the footer consists of the text of <\DEPT>, although other suitable formats could be adopted. Thus, the header identifies the name of the stakeholder, which is used by the log analyzer to suitably encode or affiliate the log data entries from the log data store 115 before storing them in the visitor database 145.

Between the header and footer of each stakeholder filter, there is at least one and possibly many filter criteria, each in the form of an expression using Regular Expression syntax, such as set out above as Expressions (1) through (3) and again, preferably in order of descending importance.

The various filter criteria in each stakeholder filter are built up as criteria are established or recognized. Typically, the remainder bin 145 is monitored 630 for entries, as these are indicative of a log data entry for which no affiliation could be deduced using the existing set of stakeholder filters and their constituent filter criteria. An item will be removed from the remainder bin 145 only after it has been added to the filter updater (see below).

When a log data entry is found in the remainder bin, the filter updater 150 attempts to identify an affiliation with the entry 635. Once an affiliation is identified, the IP address and/or domain name corresponding thereto, and potentially other related addresses and/or names may be specified as a filter criterion that may be added to the appropriate stakeholder filter.

A number of different approaches may be used. Typically, the first approach is to attempt to look up the domain name returned from the reverse DNS lookup operation in an appropriate affiliation lookup module 165. For example, if the desired affiliation is geographic, a WHOIS inquiry on the Internet will generally return a mailing address for the registrant of the domain name.

The returned domain name may then be used to access an affiliation database. For example, if the desired affiliation is by industry sector, a suitable inquiry may be to an online NAICS database of corporations, such as the NAICS Associations Business USA Directories, which lists over 14 Million U.S. businesses and their corresponding codes with an estimated accuracy of greater than 96%.

Other affiliation lookup modules 165 will become apparent to those having ordinary skill in this art upon consideration of the type of affiliation and the nature and type of affiliation lookup modules 165 in existence without departing from the spirit and scope of the present invention.

Finally, if the foregoing approaches do not bear fruit, the WHOIS inquiry may disclose relevant information about the registrant that would lead to a train of inquiry to arrive at the desired affiliation characteristic, or to access the web-site associated with the domain name of the registrant to uncover information about the registrant and its affiliation may be advisable. Such information may include line of business, contact information, products, services stock symbols, some or all of which may be appropriated by the filter update 150 to identify an affiliation.

If the attempt at identifying an affiliation is successful, the filter updater 150 then proceeds to create a filter criterion encapsulating the log data entry 645.

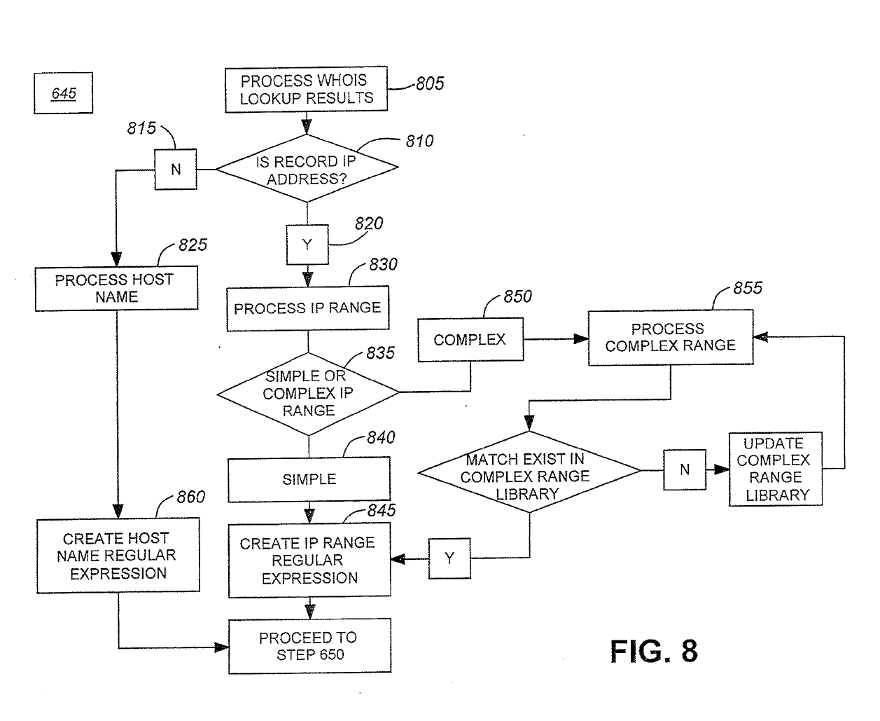

FIG. 8 shows example processing steps in performing this step.

In a majority of cases, the Reverse DNS lookup operation is successful 805 so that a domain name has been returned together with the IP address recorded in the corresponding log data entry. In such a case 815, it is usually a matter of setting the criterion to trap visitors having a domain name that matches significant portions of the returned domain name 825.

If no domain name is returned 820, then the IP address may be scrutinized to determine a range of IP addresses that are likely to satisfy the criterion 830. DNS lookups typically return information including ownership, mailing addresses and/or contact information, DNS servers used, expiry date of listings, which may be appropriated to identify the business entity that owns the IP address range and from which an affiliation may be derived.

Once the process of identifying ownership and filter categorization of IP ranges and host names from the remainder bin 140 is complete, an automated process to create regular expression filter strings is begun. The process analyzes the IP ranges and host names in a systematic way to enable a precise regular expression representation of the range or host name.

With respect to IP ranges, and due to their inherent complexity, this process considers many mathematical calculations and comparisons. For example, it considers a range of 192.168.0.0-192.168.255.255 840 and rewrites the regular expression equivalent of “̂192.\168\.” 846. This example represents all IP addresses which start with 192.168. in plain language terms. In a case where the range is more complex, such as 192.168.15.0-192.168.15.127 the expression creation process performs a lookup in a library of expressions to represent the last element in this example (i.e. 0-127 855). This regular expression would therefore be rewritten as “̂192\.168\.15\. ([0-9]|[0-9][0-9]|1[01][0-9]|12[0-7])$”.

A similar process is completed on host names, whereas the entire host string is analysed, broken down to individual segments (i.e. each string component separated by decimals), and systematically rewritten in a regular expression format which encompasses all visitors from that root host.

In the following example, the string is separated to components which are each written backwards for text string analysis.

Host example: computer1.adsI.isp.com

This string is broken down to 4 elements consisting of the following:

### Segment 1=moc

### Segment 2=psi

### Segment 3=Isda

Segment 4=1retupmoc

In general, it is known that all visitors from the root domain are represented by one and only one organization or visitor type. In this case, all those visiting with a host name ending in “.isp.com” could, for example, represent people browsing from their home through their internet service provider (i.e. “isp.com” which might service residential markets in the southeastern United States).

Depending on the number of segments in the host name, the regular expression is automatically rewritten as “\.isp\.com” in this case. In another example where a host name may consist of 2 segments, as simple as “̂isp\.com”, the regular expression is rewritten as “̂isp.com”. The final outcome is the filter string which is subsequently inserted to the appropriate location in the configuration file as follows (for the host name expression):

<member type=“host”method=“match_regexp”>\.isp\.com</member>

Or as follows for the IP range expression:

<member type=“host”method=“match_regexp”>̂192\.168\.</member>

In either case, a filter criterion is then added to the appropriate stakeholder filter 650 so that future occurrences of a log data entry corresponding to the entry being processed will be correctly trapped by the stakeholder filter.

In addition to updating the stakeholder filter, preferably upon complete re-importation of all data once the configuration file and filter is updated, the log data entry being processed is stored in the visitor database 145 in association with the now-identified affiliation 655.

On the other hand, if the affiliation attempt was not successful, the log data entry being processed is returned to the remainder bin in the hopes that a later attempt at developing an affiliation for it will be successful.

Whether or not the affiliation identification step 635 is successful, the filter updater 150 thereafter moves on to a next log data entry, if any exist, in the remainder bin.

The extent to which the affiliation of all visitors falling within a stakeholder category may be identified may vary from one stakeholder to another.

With some, there may be a high degree of confidence that a filter developed to capture stakeholders of a given category will be highly effective, say on the order of in excess of 90% of all visitors falling within the identified category. Such categories are denoted, for the purposes herein, as “comprehensive” stakeholder and/or filters. In the exemplary situation of the federal government web-site identified above, this may include the federal government, state governments and major news media categories.

With other categories, such a high degree of confidence may be unrealistic, at least without expenditure of considerable effort and resources, but there is a reasonable assurance of capturing at least an acceptable cross-section of visitors falling within the category. Such categories are denoted, for the purposes herein, as “representative” stakeholders and/or filters. In the exemplary situation identified above, the remaining identified stakeholder categories and their corresponding filters are assumed to be representative.

Typically, a sufficiently large sample to generate an accurate sample group for purposes of measure unit is achieved. According to the law of large numbers that will be familiar to those having ordinary skill in the art, with sufficient data, information based on expectations of a stake holder group may be extrapolated from a sample of suitable size within an acceptable margin of error. For example, the system 100 may be configured to generate a filter group to be added to the filter configuration store 135 upon identifying at least 1500 visits from a particular “group”.

A certain subset of the identified stakeholders, whether characterized as representative or comprehensive, may also be identified by the web-site owner/operator as constituting a “key” stakeholder. For example, in the exemplary scenario identified above, major news media, federal government and post-secondary institutions, may be so identified.

Having said this, those having ordinary skill in this art will appreciate that, with one of the advantages of the Internet being its capacity for anonymity, there will inevitably remain a portion of visitors that remain to one degree or another, relatively impervious to affiliation.

Indeed, there will be some segment of the visitor population who will take active and often drastic steps to avoid affiliation. For example, for purposes of hacking or industrial and even international espionage, entirely new dummy domain names and web-sites may be established, with a complicated chain of routing paths across the country and across national borders, solely for the purpose of “cloaking” or avoiding ex post facto reconstruction of the path along which access to the web-site was sought, much less on-the-fly affiliation as envisaged by the present invention. Visitors having such attributes are determined to avoid any attempt at identification and generally succeed.

In addition to the foregoing, there may exist a proportion, to a greater or lesser degree, of visitors who despite having made no deliberate attempt at avoiding affiliation, will nevertheless succeed at escaping categorization, at least initially. These may include publicly-accessible Internet café sites identifiable only to the ISP supplying the Internet access, particularly in foreign jurisdictions.

As a result of the foregoing, it is to be expected that not all visitors to a web-site will be categorized according to a stakeholder affiliation. Anecdotal estimates set a theoretical limit of non-affiliation in accordance with the state of affairs in 2007 at somewhere between 8% and 25% of visitor traffic to a typical web-site.

As may be deduced from the foregoing, the system 100 acts as a manner of expert system which learns from past behaviour. In particular, as affiliations are identified, their associated filter criteria may be used by the system 100 to affiliate other log data entries. Further, the process of identifying an affiliation for a given log data entry may give rise to the identification of a further methodology of identifying an affiliation and/or an additional affiliation lookup module 165 that may be useful in the exercise.

Indeed, the affiliation identification feature described above may be employed to develop all of the filter criteria for each of the stakeholder filters from an initial “blank” state. In effect, the filter updater 150 would create blank stakeholder filters, so that all of the first log data entries would generally fall through to the remainder bin. As each entry fell in to the remainder bin and was processed, the task of developing filter criteria would commence, until such point as a substantial number of log data entries would be trapped and affiliated without passing through to the remainder bin.

Conceptually, the filter updater 150 may conduct affiliation identification in parallel with the log analyzer 120 processing log data entries. Alternatively, especially if the log analyzer 120 operates in a batch mode, as discussed previously, the filter updater 150 may only periodically invoke its affiliation identification activity, preferably timed to occur between periods where consecutive batches of log data entries are being processed by the log analyzer 120.

The speed of learning of such an inventive system 100 may be greatly accelerated when a plurality of different stakeholder sets, typically corresponding to different web-sites under scrutiny 105, are being processed in parallel. It is not infrequently the case that the different emphasis on the affiliation identification exercise engendered by different web-sites under scrutiny 105 will lead to different but complementary results, in which a log data entry which defied affiliation by the filter updater 150 in respect of a first set of stakeholders corresponding to a first web-site under scrutiny 105 may be easily resolved by the filter updater 150 in respect of a second set of stakeholders corresponding to a second web-site under scrutiny 105. This may especially be the case where the different sets of stakeholders are categorized according to different affiliation characteristics, as a first affiliation lookup module 165 may quite easily return information concerning a given log data entry, while a second affiliation lookup module 165 may not return any information at all. Generally, once at least a single affiliation has been identified, the process of applying other affiliation criteria to the log data entry becomes relatively straightforward.

In a centralized system 100, in which a common filter updater 150 is performing the affiliation identification task for all stakeholder sets such cross-pollination of stakeholder sets may be easily accomplished. Nevertheless, cross-pollination may still occur where each stakeholder set has a different system 100 with a different filter updater 150. In the latter circumstance, the various systems 100 may incorporate (not shown) a communication link or a filter criteria exchange mechanism whereby the collective knowledge of each system 100 may be circulated for the benefit of related systems 100.

Because of the potential for cross-pollination between stakeholder sets, it is advantageous to have the filter updater 150 periodically take all of the log data entries remaining in the remainder bin and pass them through all existing stakeholder filters, in case that another system 100 has developed a set of filter criteria that could be used to affiliate these entries.

With liberal use of the inventive system 100, especially with the potential advantages of cross-pollination, a system 100 employing cross-pollination over a substantial period of time may well approach the theoretical limits of non-affiliation discussed previously.

Furthermore, having regard to the approaches described herein, including judicious application of proxies, as described hereinbelow, there may in fact be some degree of information concerning some of the visitors who would otherwise fall into such a “black hole” categorization, suggesting or inferring affiliation with an identified stakeholder, whether on a representative or comprehensive basis.

In the above-described fashion, the inventive system 100 permits the categorization of most, if not all of the log data entries for a web-site under scrutiny 105 according to a desired affiliation criteria, on a batch and/or ongoing basis.

Armed with such valuable categorization information, the system 100 may thereafter proceed to provide insightful and valuable analysis of the web-site traffic in a manner and to a level of detail and precision heretofore unavailable. This is accomplished using the report creator 160.

The report creator 160 responds to queries from the user terminal 155 in response to which the report creator 160 may access the visitor database 145, in order to generate reports to the user terminal 155.

For example, key visitor profiles may be identified by the report creator 160, showing the visitor traffic patterns and tendencies according to the identified affiliation and stakeholder values. Within each stakeholder or profile, the time, frequency and manner of use of the website under scrutiny 105 may be identified, with increased precision. The types of pages of web-site content may be precisely identified by affiliation category, with the result that very precise observations regarding visitor preferences may be made, at a level of detail that is unavailable when analyzing the traffic as a whole.

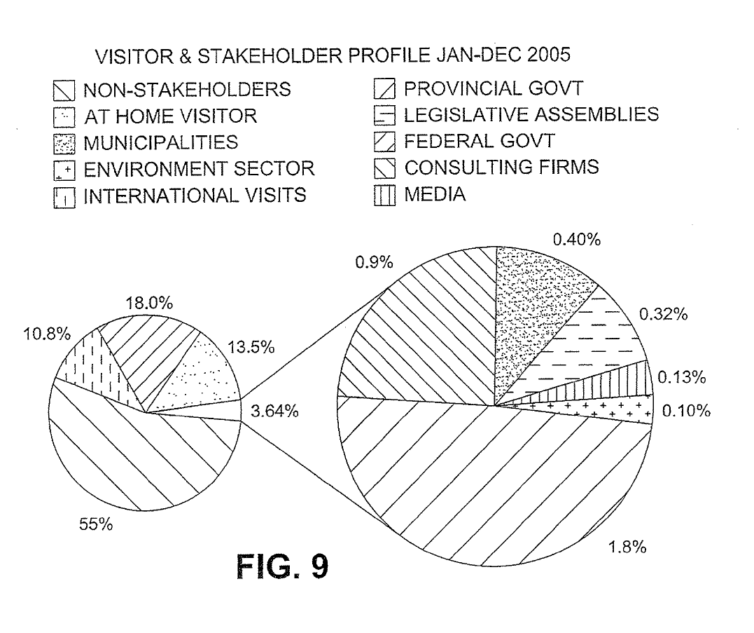

Thus, for example, one could identify the relative proportion of all visitors to the web-site under scrutiny 105 occupied by each stakeholder in the stakeholder set, as shown in exemplary format in FIG. 9.

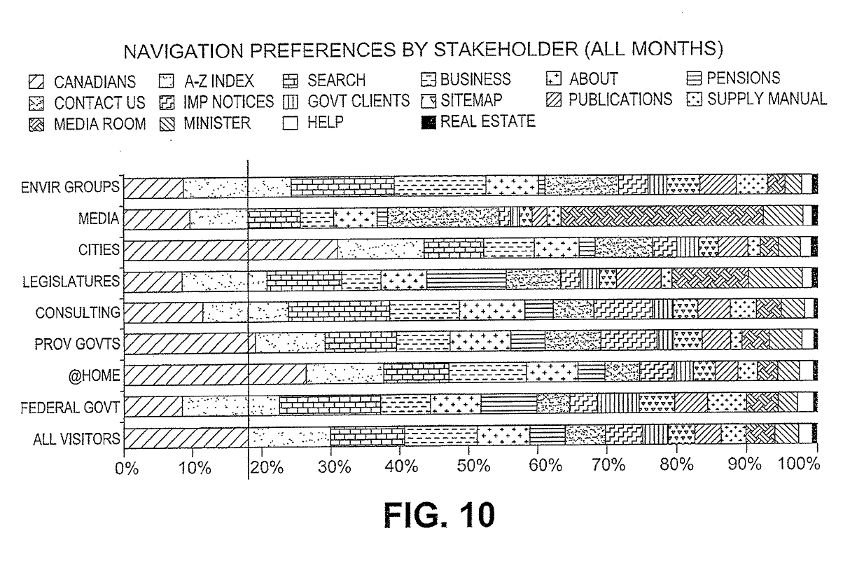

Further, one could identify which sections of the web-site under scrutiny 105 are most popular with each different stakeholder, as shown in exemplary format in FIG. 10.

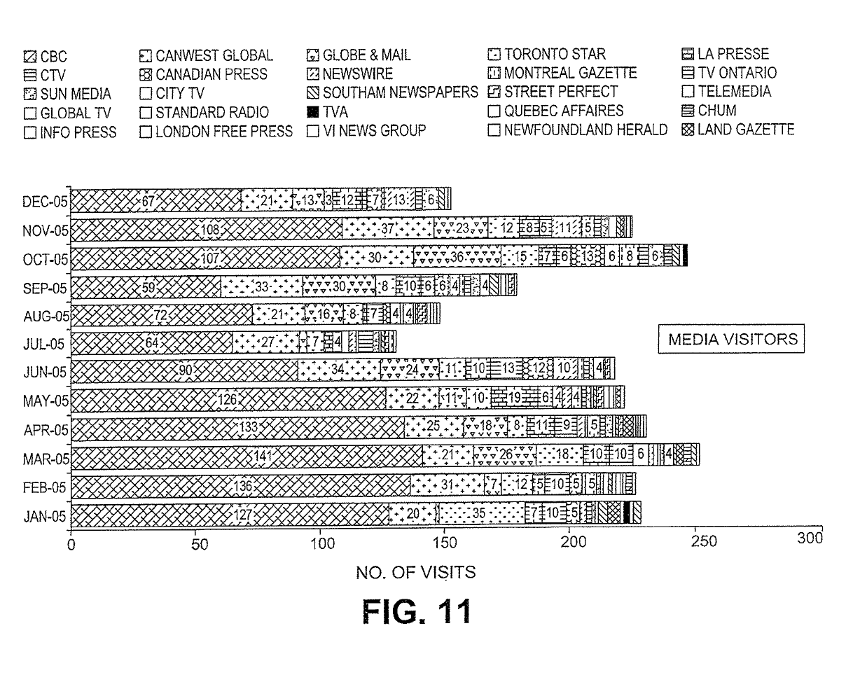

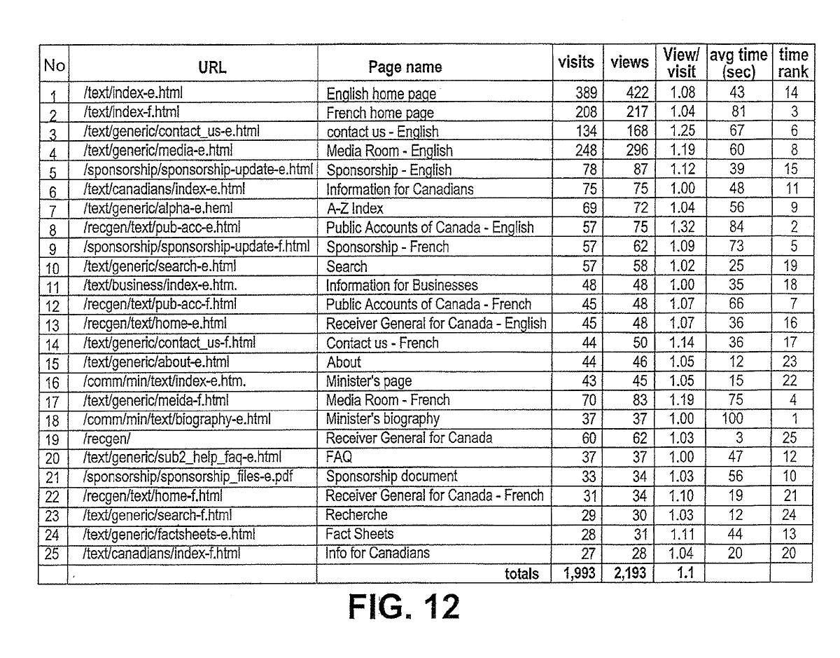

Alternatively, one could identify with precision, which individual entities corresponding to a key stakeholder access the web-site under scrutiny 105, as shown in exemplary format in FIG. 11, or even what topics and content are preferred by members of this key stakeholder, as shown in exemplary format in FIG. 12.

Other reports and content analysis that make use, to a greater or lesser extent, of the affiliation information provided by the system and method of the present invention will become apparent to those having ordinary skill in this art.

The present invention can be implemented in digital electronic circuitry, or in computer hardware, firmware, software, or in combination thereof. Apparatus of the invention can be implemented in a computer program product tangibly embodied in a machine-readable storage device for execution by a programmable processor; and methods actions can be performed by a programmable processor executing a program of instructions to perform functions of the invention by operating on input data and generating output. The invention can be implemented advantageously on a programmable system including at least one input device, and at least one output device. Each computer program can be implemented in a high-level procedural or object-oriented programming language, or in assembly or machine language, if desire; and in any case, the language can be a compiled or interpreted language.

Suitable processors include, by way of example, both general and specific microprocessors. Generally, a processor will receive instructions and data from a read-only memory and/or a random access memory. Generally, a computer will include one or more mass storage devices for storing data file; such devices include magnetic disks and cards, such as internal hard disks, and removable disks and cards; magneto-optical disks; and optical disks. Storage devices suitable for tangibly embodying computer program instructions and data include all forms of volatile and non-volatile memory, including by way of example semiconductor memory devices, such as EPROM, EEPROM, and flash memory devices; magnetic disks such as internal hard disks and removable disks; magneto-optical disks; CD-ROM and DVD-ROM disks; and buffer circuits such as latches and/or flip flops. Any of the foregoing can be supplemented by, or incorporated in ASICs (application-specific integrated circuits), FPGAs (field-programmable gate arrays) and/or DSPs (digital signal processors).

Examples of such types of computer are programmable processing systems contained in the log analyzer 120, the remainder bin 140, filter updater 150 and report creator 160 suitable for implementing or performing the apparatus or methods of the invention. The system may comprise a processor, a random access memory, a hard drive controller, and/or an input/output controller, coupled by a processor bus.

It will be apparent to those having ordinary skill in this art that various modifications and variations may be made to the embodiments disclosed herein, consistent with the present invention, without departing from the spirit and scope of the present invention.

While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

Further, the foregoing description of one or more specific embodiments does not limit the implementation of the disclosure to any particular computer programming language, operating system, system architecture or device architecture.

Also, the term “couple” in any form is intended to mean either a direct or indirect connection through other devices and connections.

Moreover, all dimensions described herein are intended solely to be exemplary for purposes of illustrating certain embodiments and are not intended to limit the scope of the invention to any embodiments that may depart from such dimensions as may be specified.

In the particular context of the present disclosure, it should be understood that a number of e-mail addresses and web-site/domain names may be provided by way of example and illustration, both in the text and in the figures. Any resemblance to existing addresses and names is unintentional and purely coincidental and should not be presumed to make reference to an existing person, enterprise or web-site.

Directional terms such as “upload”, “download”, “left” and “right” are used to refer to directions in the drawings to which reference is made unless otherwise stated. Similarly, words such as “inward” and “outward” are used to refer to directions toward and away from, respectively, the geometric centre of a device, area and/or volume and/or designated parts thereof.

References in the singular form include the plural and vice versa, unless otherwise noted.

Certain terms are used throughout to refer to particular components. As one skilled in the art will appreciate, manufacturers may refer to a component by different names. It is not intended to distinguish between components that differ in name but not in function.

The purpose of the Abstract is to enable the relevant Patent Office and/or the public generally, and especially persons having ordinary skill in the art who are not familiar with patent or legal terms or phraseology, to quickly determine from a cursory inspection the nature of the technical disclosure. The Abstract is neither intended to define the invention of this disclosure, which is measured by its claims, nor is it intended to be limiting as to the scope of this disclosure is any way.

Other embodiments consistent with the present invention will become apparent from consideration of the specification and the practice of the invention disclosed herein.

Accordingly, the specification and the embodiments disclosed therein are to be considered exemplary only, with a true scope and spirit of the invention being disclosed by the following claims.

What is claimed is:

1. A system for determining an affiliation of at least one visitor to a web-site under scrutiny, the system comprising:
a filter updater for maintaining at least one stakeholder filter and at least one constituent criterion thereof; and
a log analyzer for comparing a log data entry corresponding to one of the at least one visitors against at least one constituent criteria of one of the at least one stakeholder filters and for storing it in a database in association with one of the at least one stakeholder filters if it satisfies one of the at least one constituent criteria thereof;
wherein the one of the at least one visitors associated with the log data entry may be affiliated with a stakeholder corresponding to the stakeholder filter whose constituent criterion the log data entry satisfies.

2. The system according to claim 1, wherein if the log data entry does not satisfy any of the at least one constituent criteria of any of the at least one stakeholder filters, the log analyzer may forward the log data entry to the filter updater and the filter updater may develop a constituent criterion of one of the at least one stakeholder filters corresponding thereto and may update one of the at least one stakeholder filters accordingly.

3. The system according to claim 1, wherein one of the at least one constituent criteria corresponds to a range of originating data selected from a group consisting of an IP address and a domain name.

4. The system according to claim 1, wherein the log analyzer may derive an originating domain name from an originating IP address associated with the log data entry.

5. The system according to claim 2, further comprising at least one affiliation lookup module for accepting the log data entry and returning affiliation identification data corresponding thereto by which the filter updater may identify which of the at least one stakeholder filters to update.

6. The system according to claim 5, wherein the at least one affiliation lookup module is identified with a second system according to claim 1 and corresponding to a second set of at least one stakeholder filters.

7. The system according to claim 5, wherein the at least one affiliation lookup module returns affiliation identification data based on characteristics identified in a second system according to claim 1 and corresponding to a second set of at least one stakeholder filters.

8. The system according to claim 1, further comprising a report creator for generating a report on behavior of the at least one visitors to the web-site under scrutiny categorized according to the affiliation of the at least one visitors.

9. A method for determining an affiliation of at least one visitor to a web-site under scrutiny, the method comprising the steps of:
a. maintaining at least one stakeholder filter and at least one constituent criterion thereof;
b. comparing a log data entry corresponding to one of the at least one visitor against each of the at least one constituent criteria of each of the at least one stakeholder filter; and
c. storing it in a database in association with one of the at least one stakeholder filters if it satisfies one of the at least one constituent criteria thereof;
wherein the one of the at least one visitors associated with the log data entry may be affiliated with a stakeholder corresponding to the stakeholder filter whose constituent criterion the log data entry satisfies.

10. The method according to claim 9, further comprising steps, before step b. of:
a.1. developing a constituent criterion of one of the at least one stakeholder filters; and
a.2. updating the one of the at least one stakeholder filters accordingly.

11. The method according to claim 9, wherein step b. comprises deriving an originating domain name from an originating IP address associated with the log data entry.

12. The method according to claim 9, further comprising the step of:
d. generating a report on behavior of the at least one visitors to the web-site under scrutiny categorized according to the affiliation of the at least one visitors.

13. The method according to claim 9, wherein step a. comprises creating a stakeholder filter with no constituent criteria therein.

14. The method according to claim 10, wherein steps a.1. and a.2. are performed in respect of a log data entry that does not satisfy any of the at least one constituent criteria of any of the at least one stakeholder filters

15. A filter updater for use in a system for determining an affiliation of at least one visitor to a web-site under scrutiny, the filter updater for maintaining at least one stakeholder filter and at least one constituent criterion thereof,
whereby a log data entry corresponding to one of the at least one visitors may be compared against one of the at least one constituent criteria of one of the at least one stakeholder filters and stored in a database in association with one of the at least one stakeholder filters if it satisfies one of the at least one constituent criteria thereof, so that one of the at least one visitors associated with the log data entry may be affiliated with a stakeholder corresponding to the stakeholder filter whose constituent criterion was satisfied by the log data entry.

16. The filter updater according to claim 15, further comprising a criterion creator for developing a constituent criterion of one of the at least one stakeholder filters corresponding thereto and updating the one of the at least one stakeholder filters accordingly.

17. A filter updater according to claim 15, further comprising at least one affiliation lookup module for accepting the log data entry and returning affiliation identification data corresponding thereto by which the filter updater may identify which of the at least one stakeholder filters to update.

18. A log analyzer for use in a system for determining an affiliation of at least one visitor to a web-site under scrutiny, for comparing a log data entry corresponding to one of the at least one visitors against each of at least one constituent criterion in each of at least one stakeholder filter and for storing the log data entry in a database in association with one of the at least one stakeholder filters if it satisfies one of the at least one constituent criteria thereof, wherein the one of the at least one visitors associated with the log data entry may be affiliated with a stakeholder corresponding to the stakeholder filter whose constituent criterion the log data entry satisfies.

19. The log analyzer according to claim 18, further comprising a domain name identifier for deriving an originating domain name from an originating IP address associated with the log data entry.

20. An affiliation lookup module for use in a system for determining an affiliation of at least one visitor to a web-site under scrutiny, for accepting a log data entry corresponding to one of the at least one visitors and returning affiliation identification data corresponding thereto by which the log data entry may be identified as being associated with one of at least one stakeholder.
